(19) United States
(12) Patent Application Publication
(10) Pub. No.: US 2026/0301739 A1
(43) Pub. Date: Oct. 1, 2026

(54) SYSTEMS AND METHODS FOR RESOLVING SPEECH AMBIGUITY WITH VISUALIZATION

(71) Applicant: Adeia Guides Inc., San Jose, CA (US)

(72) Inventors: Ning Xu, Irvine, CA (US); Zhiyun Li, Kenmore, WA (US); Aldis Sipolins, Somerville, MA (US); Tao Chen, Palo Alto, CA (US)

(21) Appl. No.: 19/089,318

(22) Filed: Mar. 25, 2025

(51) Int. Cl. G10L 15/197; G06F 3/01; G10L 15/02; G10L 21/0208; G10L 25/63

(52) U.S. Cl. CPC G10L 15/197; G06F 3/013; G10L 15/02; G10L 21/0208; G10L 25/63; G06F 2203/011

(57) ABSTRACT

Methods and systems are described herein for generating content corresponding to an ambiguous term in speech. In an example system, speech data is received via a microphone, such as of a head-mounted display (HMD). The system determines text data from the speech data, identifies an ambiguous term in the text data, and determines a weight for each of a plurality of interpretations for the ambiguous term based at least in part on biometric data, such as a brain-computer interface (BCI) signal, and/or other mood data. The system selects a subset of the plurality of interpretations, based on the weights, to generate a prompt for each of the subset of the plurality of interpretations to input into a generative model to generate one or more candidate visual options. The system may provide for display, on an internal display of the HMD, the one or more candidate visual options for the subset of the plurality of interpretations.

### BACKGROUND

This disclosure relates to systems and methods for generating content. More specifically, this disclosure relates to systems and methods for generating content corresponding to an ambiguous term in speech.

### SUMMARY

Extended reality (XR) applications facilitate conveying information about detected objects, text, speech and more. With XR, words can be supplemented with images, videos, and other digital content, and visual objects can be described with text, audio, translations, etc. XR can comprise mixed reality (MR), virtual reality (VR), and/or augmented reality (AR). When XR is implemented with voice recognition applications, deciphering context and meaning may not be straightforward and, as a result, the XR supplemental content may not convey information accurately.

As language continually evolves, the nuances and ambiguities that arise in speech and writing make it increasingly challenging to convey intentions with precision to all audiences.

Common sources of ambiguity come from homonyms (words with the same spelling (and often pronunciation) but different, unrelated meanings, such as “date,” meaning a calendar day or a fruit); homophones (words with the same pronunciation but different spelling and meanings, such as “buy,” “by,” and “bye”); and polysemous words (words with the same spelling but different, related meanings, such as “wave,” meaning movement of water, a hand gesture, or a pattern of energy). Furthermore, the proliferation of slang, the spread of internet vernacular, the advent of emoji communication, the increase in sarcasm, and the widening generational and cultural divides all contribute to the complexities of achieving clear communication.

In one approach, speech recognition and artificial intelligence (AI) have made it possible to generate content (e.g., images, videos, audio, text, etc.) based on verbal descriptions (e.g., speech, commands, dictation, dialogue, lyrics, etc.). Such approaches rely on assigning weights to parts of the speech input based on a contextual analysis of surrounding words, patterns of co-occurring words, syntactic structure of the input, or named entity recognition (NER) of proper nouns to make a single prediction for the intent of the ambiguous words or phrases. However, these techniques often fail in several scenarios. For example, the input may lack sufficient context for the prediction (e.g., “I saw her duck,” wherein “duck” could be a verb or a noun). In another example, training biases may discount lower-probability context possibilities (e.g., “The accountant went to the bank,” wherein “bank” is a riverbank). As another example, speech may be transcribed using the incorrect homonyms, homophones, or polysemous words (e.g., “Where is the flower?” wherein the input intended “flour”). Furthermore, the input may contain humor, sarcasm, or idioms that are poorly suited for logical predictions (e.g., “The test was a piece of cake”). The techniques may also fail when the training data does not include new or rare word usages reflecting current and emerging language (e.g., the term “rizz” emerging as a slang word for “charisma”). Moreover, NER may fail for multiple proper nouns (e.g., “Paris is beautiful,” wherein “Paris” is a person, not the city). As another example, these techniques may fail when an accent or dialect of the input is not detected (e.g., a British accent pronouncing “cot” may be interpreted as “caught,” meaning to capture, using a default American context rather than a British context where “cot” is commonly known as a small bed or crib) or when a language translation does not have an equivalent counterpart in the target language (e.g., the Danish word “hygge,” which embodies a feeling of comfort, contentment, and well-being through simple and everyday experiences, but has no direct English translation). Conventional approaches (e.g., text-to-image generation) often produce a single best guess without providing a means for addressing ambiguities in the input and prior to accepting subsequent input to clarify. This inadequacy can result in system misinterpretations, repeat inferencing (e.g., additional resources), and miscommunication.

Converting natural language into precise visual outputs is a difficult undertaking. Many approaches rely solely on textual inputs and deterministic rules, which lack the flexibility and expressiveness to output precise visual representations of the input. Language models provide techniques for weighting context within the input to allow the models to produce contextually rich imagery. However, as mentioned, these approaches have several failure points when inferencing ambiguous words and phrases, as well as user-specific nuances. These approaches also typically fail to account for their calculated uncertainties and fail to integrate feedback loops to disambiguate competing interpretations before committing to a visualization.

In some approaches, language models may be leveraged for speech understanding in XR applications via head-mounted displays (HMDs). While these HMDs can provide rich visual experiences for the wearer, the employed language model typically treats speech as a one-dimensional stream of text, having no means to incorporate non-verbal cues (e.g., eye gaze, mood, subtle neural signals, etc.) that could clarify ambiguities.

Consequently, despite considerable progress in speech recognition and generative AI, there exists a need for a cohesive solution for addressing speech input ambiguity at the onset of content generation.

To help address this gap, systems and methods are provided herein for resolving speech ambiguity with visualization (e.g., text, images, video, AR, VR, MR, XR, projections, etc.). For example, the methods and systems comprise real-time speech disambiguation through integration of non-verbal cues and/or auxiliary signals (e.g., brain-computer interface (BCI) data, mood data, gaze data, etc.) and feedback to generate a visual representation of an ambiguous term or phrase. In some embodiments, this system is integrated into an HMD.

In some embodiments, the system mitigates computational costs of approaches resulting in repeat inferencing, bandwidth requirements for data transmission, response time lag, memory and storage requirements, and retraining cycles to correct errors in interpretation by proactively addressing input ambiguities and actively updating based on a feedback loop. To illustrate, current approaches may receive the audio input “I saw a Jaguar” and generate an image of an animal instead of the intended car. To correct this, current approaches require additional inputs with more specific details and context, resulting in additional inferencing and the aforementioned computational costs. In contrast, for example, the system, described herein, may receive the audio input “I saw a Jaguar” and determine BCI data, at the time of input, indicates mechanical or engineered structures, or determine mood data, at the time of input, is characterizable as calm. Based at least in part on these auxiliary signals, the system may, with sufficient confidence, generate a visualization of the car for an external display (e.g., external display of HMD, an internal display of a different HMD, a different external display (e.g., phone display, computer display, watch display, tablet display, e-reader display, car display, television display, projection, or digital display), or any combination thereof). Based at least in part on these auxiliary signals, the system may, with insufficient confidence, generate preliminary (e.g., with lower resolution) candidate visualizations of the car and animal for feedback selection on an internal display (e.g., internal display of HMD, or any suitable personal display) prior to generating a visualization on the external display. Feedback selection may be received in the form of BCI data, mood data, eye gaze data, head gaze/tilt/movement data, gesture data, voice data, and/or any other desirable signal or any combination thereof. Based on the selection, the system may generate a visualization of the car for an external display. Furthermore, the feedback selection may be used to refine the system confidence determination for future inferences.

In some embodiments, the system receives speech data via a microphone, determines text data from the speech data, and identifies an ambiguous term in the text data. The system may determine a plurality of interpretations for the ambiguous term and weight the interpretations using auxiliary signals (e.g., BCI data, mood data, gaze data, etc.). For example, the system may use a confidence score for each interpretation to determine if any are below a configurable threshold confidence (e.g., 40%) to remove the interpretation from the potential intended candidates. In another example, the system may use a confidence score for each interpretation to determine if any are above a configurable threshold confidence level (e.g., 80%) to directly generate an interpretation on the external display. In this example, if multiple candidates meet this criterion, the system may follow the next example for visual generation and feedback selection. In a further example, the system may use a confidence score for each remaining interpretation to determine if any are between the configurable thresholds to select the interpretations for visual generation and feedback selection. As an example, auxiliary signals provide multi-modal input for the system to determine contemporaneous non-verbal contextual support for the potential interpretations. For each system-selected interpretation, the system generates a respective prompt to input into a trained generative model to generate a visual representation. The generated visual representations are presented in regions of a display (e.g., on an internal display of an HMD, a user device, or any suitable personal display) for feedback selection. Using the methods described herein, a precise visual output from an ambiguous speech input is generated through integration of non-verbal cues and feedback.

In some embodiments, the system receives a selection of a visual representation. For example, the system may receive data from an eye-tracking sensor, cameras inside and/or outside of the device, and/or other sensors correlating to the direction of one of the displayed visual representations to navigate and/or select. In some embodiments, the system may receive BCI data and/or mood data to confirm or reject a selection suggested by the eye-tracking correlation. In the example of “I saw a jaguar,” if the system detects eye tracking correlated to selecting the animal on the left-hand side, but the BCI data, at the time of selection, indicates a familiarity signal that suggests the person does not recognize the stimulus (e.g., the animal), or determines the mood data, at the time of selection, indicates negative facial expressions (e.g., eyebrow furrowing, lip pursing, squinting, nostril flaring, etc.), increased skin conductance response (e.g., indicating emotional discomfort), erratic gaze patterns (e.g., increased blinking, shifting eye focus, longer reaction time, etc.), or any combination thereof that suggests the selection of the animal is incorrect, the system may reject that selection. On the other hand, if the system detects eye tracking correlated to selecting the animal on the left-hand side, and the BCI data, at the time of selection, indicates a familiarity signal that suggests the person does recognize the stimulus (e.g., the animal), or determines the mood data, at the time of selection, indicates positive facial expressions (e.g., relaxed eyebrows, slight smile, etc.), stable skin conductance, stable gaze patterns (e.g., reduced blinking, eye focus, shorter reaction time, etc.), or any combination thereof that suggests the selection of the animal is correct, the system may accept that selection.

In some embodiments, the system may accept or reject a selection directly based on BCI data and/or mood data. For example, the BCI data and/or mood data may be correlated with the term “red apple.” In another example, the system may receive data from a gesture (e.g., head movement, head gaze, head tilt, hand gesture, etc.) correlating to the direction of one of the displayed visual representations to navigate and/or select. In another example, the system may receive data from a button, touchscreen, or controller to navigate and/or select. Moreover, the system may receive additional speech input to navigate and/or select. Through incorporation of this feedback loop, the system confirms the intent of the input speech and provides for display (e.g., on a different display and at a better resolution) only the selected visual representation. Thus, the current system reduces repeat inferencing from misinterpretations, improves communication clarity, and reduces overall computational costs of speech-based visual generation.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts a schematic illustration of generating content corresponding to an ambiguous term in speech, in accordance with some embodiments of this disclosure.

FIG. 2 depicts a schematic illustration of system architecture for generating content corresponding to an ambiguous term in speech, in accordance with some embodiments of this disclosure.

FIG. 3A depicts a sequence diagram for generating content corresponding to an ambiguous term when confidence is below a threshold, in accordance with some embodiments of this disclosure.

FIG. 3B depicts a sequence diagram for generating content corresponding to an ambiguous term when confidence is above a threshold, in accordance with some embodiments of this disclosure.

FIG. 3C depicts a sequence diagram for generating content corresponding to an ambiguous term when confidence is above a threshold with attribute enhancement, in accordance with some embodiments of this disclosure.

FIG. 4A depicts a schematic illustration of generating content using BCI signals, in accordance with some embodiments of this disclosure.

FIG. 4B depicts a schematic illustration of generating content using mood signals, in accordance with some embodiments of this disclosure.

FIG. 5 depicts a flowchart of a process for generating content corresponding to an ambiguous term, in accordance with some embodiments of this disclosure.

FIG. 6 depicts a flowchart of a process for learning and feedback for generating content corresponding to an ambiguous term, in accordance with some embodiments of this disclosure.

FIG. 7 depicts illustrative user equipment, in accordance with some embodiments of this disclosure.

FIG. 8 depicts an illustrative user equipment system, in accordance with some embodiments of this disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

A system is provided to proactively aid verbal communication using visual aids. For example, the system is configured to integrate speech input with auxiliary signals (e.g., mood from voice characteristics, brain-computer interface data, gaze data, etc.) to determine ambiguous words or phrases in the speech input and provide visual representations of the interpretations of the ambiguous words or phrases. For instance, the system generates multiple potential visual interpretations for a determined ambiguous phrase on a private screen for eye gaze selection prior to generating a visualization of the intended interpretation of the ambiguous phrase on a public display. The system provides a communication tool comprising analysis of non-verbal signals and real-time feedback that mitigates confusion or miscommunication due to ambiguous terms.

As referred to herein, the phrases “ambiguous term,” “ambiguous word,” and “ambiguous phrase,” refer to terms, words, and phrases that may be interpreted in more than one way; have a plurality of meanings; are part of a homonym, homophone, or polysemous word set; are eggcorns (e.g., a word or phrase that results from a mishearing or misinterpretation of another); and/or do not have a direct translation.

As referred to herein, the phrases “visualization,” “visual option,” and “visual interpretation” refer to any visual media (e.g., images, videos, text, AR, VR, MR, XR, projections, etc.) and may be accompanied with corresponding audio.

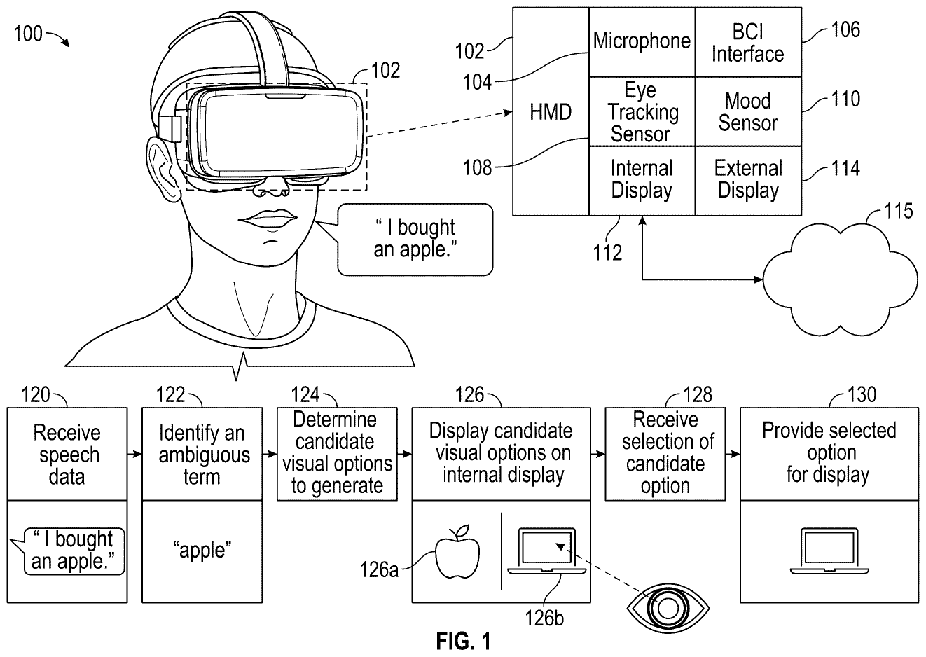

FIG. 1 depicts a schematic illustration 100 of generating content corresponding to an ambiguous term in speech, in accordance with some embodiments of this disclosure.

In some embodiments, the system is an HMD 102 comprising a microphone 104, a BCI interface 106, an eye-tracking sensor 108, a mood sensor 110, an internal display 112, and an external display 114. In some embodiments, the system may comprise either a BCI interface or a mood sensor. In some embodiments, the system may not comprise an eye-tracking sensor and utilizes one or more of the microphone, the BCI interface, and/or the mood sensor to determine selections (e.g., head rotation to select options). The system may be connected to external servers and/or databases via communication network 115.

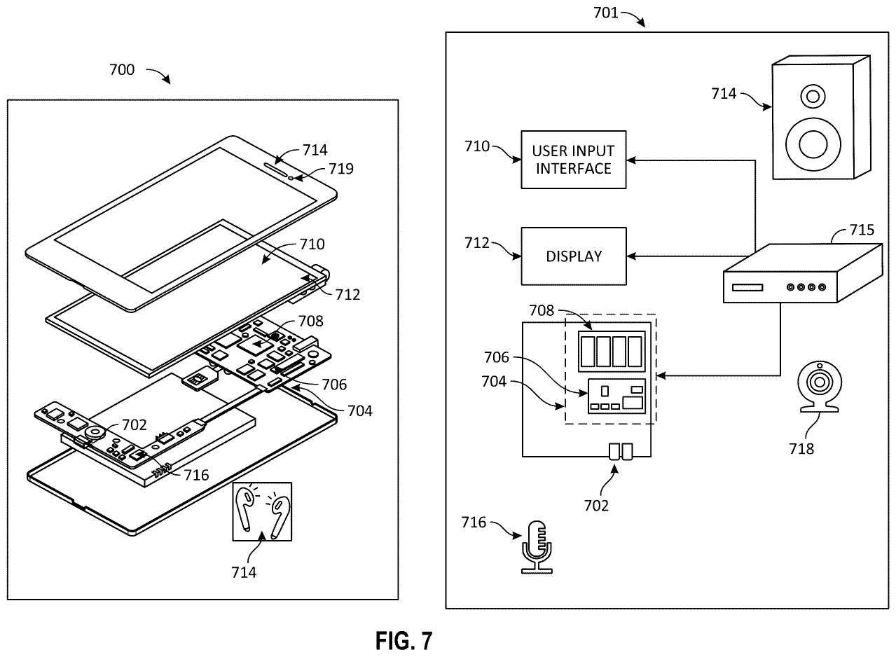

In some embodiments, the system actively samples for voice inputs to determine ambiguous words or phrases. In other embodiments, the system passively samples for voice inputs, and may be triggered (e.g., through input via a gesture, input/output (I/O) path 702 of FIG. 7, or through system determination (e.g., BCI signals, mood signals, facial detection signals, etc., indicative of uncertainty) to determine ambiguous words or phrases.

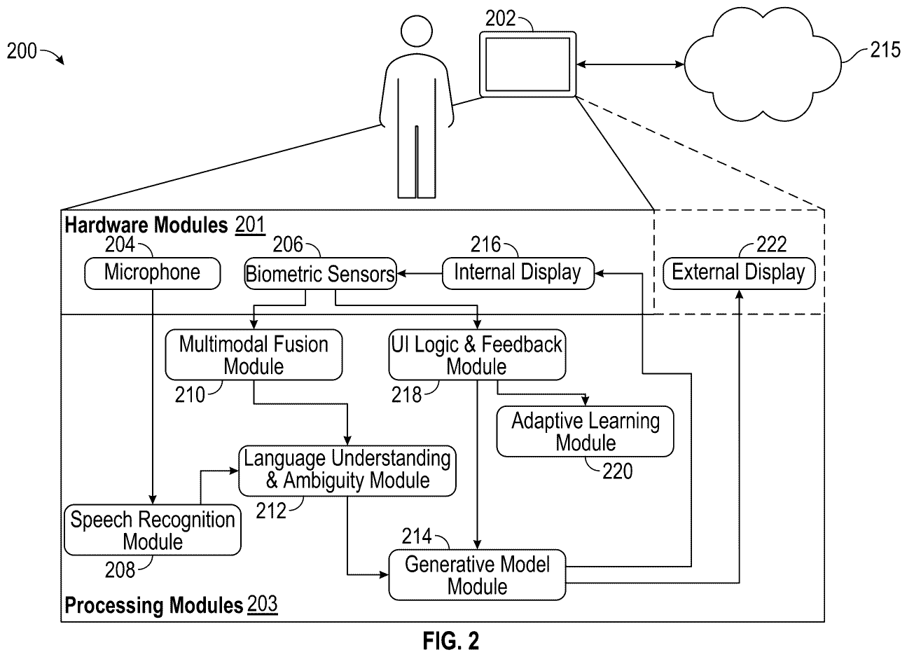

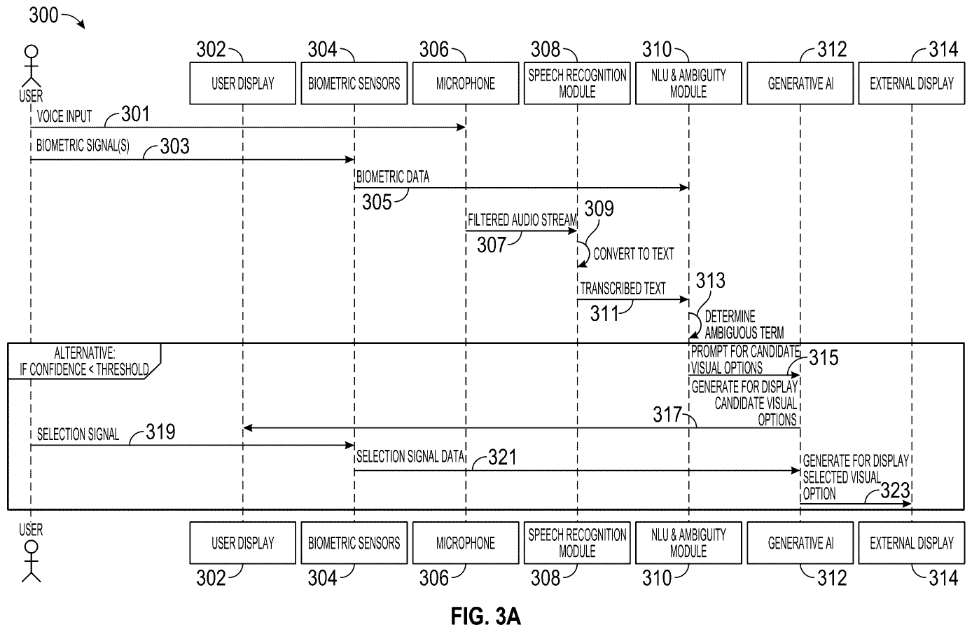

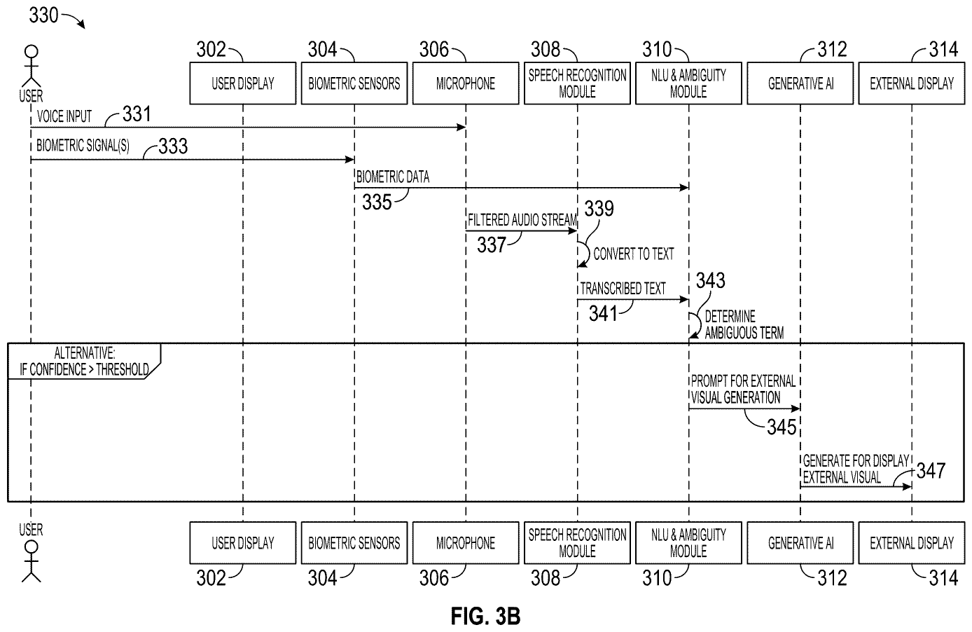

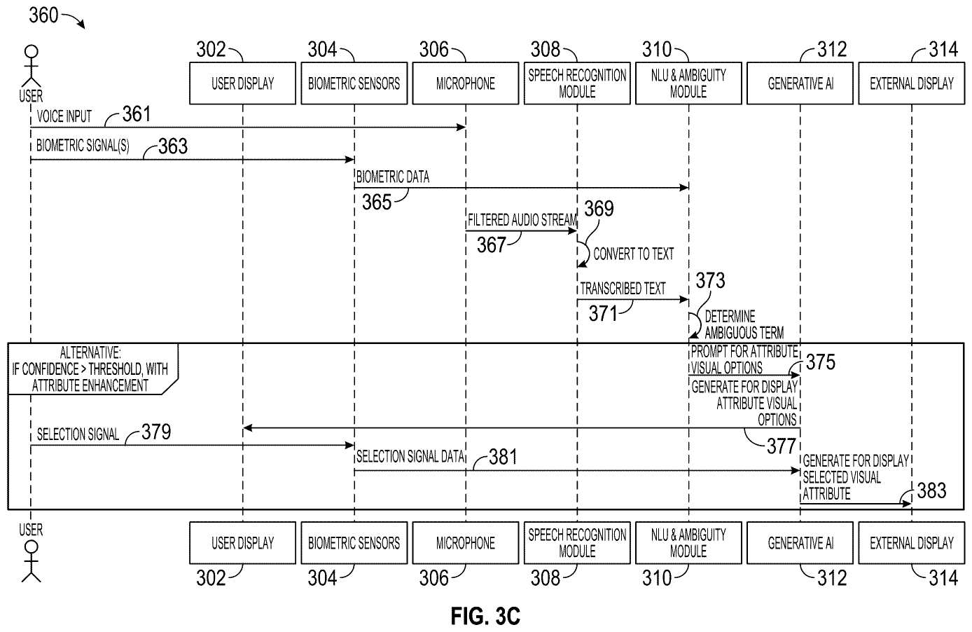

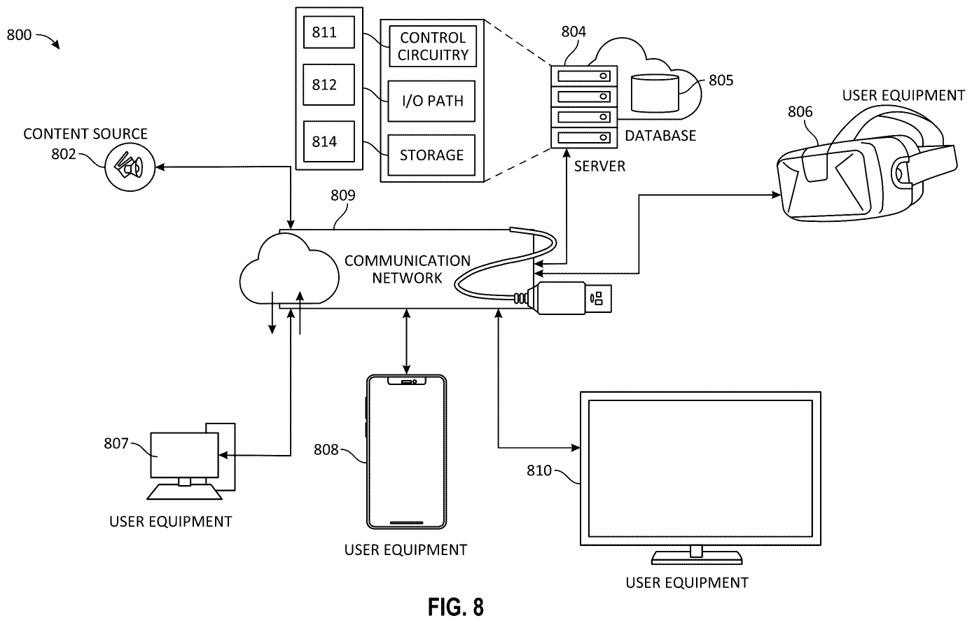

For example, HMD 102 may receive the speech data “I bought an apple” through microphone 104 at step 120. In parallel, the HMD 102 may receive BCI data through BCI interface 106, mood data through mood sensor 110, and eye-tracking data through eye-tracking sensor 108. At step 122, the HMD converts the speech to text and identifies the ambiguous term, “apple” using a natural language understanding (NLU) & ambiguity detection engine (e.g., language understanding & ambiguity module 212 of FIG. 2, and NLU & ambiguity module 310 of FIG. 3). In some embodiments, the NLU & ambiguity detection engine may comprise, e.g., one or more servers (e.g., server 804 of FIG. 8), working separately or together, comprising a neural network, trained model, etc.

In some embodiments, the NLU & ambiguity detection engine may compare the transcribed text, BCI data, mood data, and eye-tracking data to a data structure (e.g., containing ambiguous words and phrases associated with a set of possible interpretations and metadata for each interpretation) to determine whether multiple interpretations exist for each word or phrase of the voice input. In some embodiments, the NLU & ambiguity detection engine may compare the transcribed text, BCI data, mood data, and eye-tracking data to vector embeddings of the NLU & ambiguity detection engine to determine whether multiple interpretations exist for each word or phrase of the voice input. For example, vector embeddings are numerical representations of data in a continuous vector space used to encode complex data (e.g., words, images, patterns, behaviors, etc.) as embeddings, where embeddings with similar meanings or relationships are closer in the vector space. In some embodiments, the model may represent embeddings as vectors, matrices, tensors, or any other suitable mathematical form. In some embodiments, the NLU & ambiguity detection engine may use the BCI data or mood data to determine a probability score, confidence score, or correlation score for each interpretation found in the vector embeddings or data structure of the model.

In some embodiments, the NLU & ambiguity detection engine may compare the probability score, confidence score, or correlation score for each interpretation to configurable thresholds to determine whether to eliminate interpretations (e.g., confidence score is less than elimination threshold), to proceed to visual generation on an external display (e.g., confidence score meets and/or exceeds ambiguity threshold) or to proceed to visual generation of a selection of interpretations on an internal display (e.g., elimination threshold is less than confidence score, which is less than ambiguity threshold).

For example, at step 124, the NLU & ambiguity detection engine of the HMD determines that two interpretations for “apple” have probability scores below a confidence threshold for direct external generation and above a confidence threshold for elimination. For instance, the NLU & ambiguity detection engine may determine “apple (fruit)” and “Apple® Inc.” as candidate visual options to generate and create a prompt for input into a generative AI service, application, and/or model (e.g., generative model module 214 of FIG. 2, generative AI 312 of FIG. 3A, etc.) using and/or including metadata in the data structure, vector embeddings, BCI data and/or mood data. Based on the input prompts, at step 126, the HMD 102 displays candidate visual options, e.g., 126a and 126b, on internal display 112.

In some embodiments, at step 128, the HMD 102 receives BCI data, mood data, and/or eye-tracking data to determine a selection of a visual option (e.g., steps 319 and 321 of process 300 of FIG. 3). For example, eye-tracking sensor 108 may monitor for a user gaze vector using near-infrared cameras that reflect off the user's cornea to determine the line of sight directed to visual option 126b corresponding to “Apple Inc.” In some embodiments, the HMD 102 may record dwell time on each visual region corresponding to the displayed visual options 126a and 126b. In one embodiment, the system may determine a selection of a displayed visual interpretation upon determining that a user gaze vector dwell time exceeds a configurable threshold (e.g., 200 milliseconds). In some embodiments, the system may determine a selection of a displayed visual interpretation upon determining a displayed visual interpretation of the candidate displayed visual interpretations with the longest or threshold dwell time. In certain embodiments, a classifier can be trained, based on the eye gaze vectors, to determine a selection of a displayed visual interpretation. Subsequent to the selection of a visual option, the NLU & ambiguity detection engine of HMD 102, based on the selection and the BCI data and/or mood data during the selection, generates an updated enriched text prompt (e.g., more detailed than the prompt for the plurality of candidate visual options) to input into the generative AI service, application, and/or model.

In some embodiments, at step 130, the HMD 102 provides the selected visual option for display on the external display 114. In some embodiments, the system may generate a visual on the external display at a high-resolution, a scaled-up version, or in higher computational and/or quality formats (e.g., higher resolution images, videos, audio, etc.). In some embodiments, a single multimodal neural network (e.g., NLU & ambiguity detection engine) may directly determine internal and external visual outputs based on the voice input, BCI signals, and mood signals. For example, in this embodiment an intermediate model for prompt generation into the generative model is not required.

In an embodiment, the system may use text-to-video rather than text-to-image to generate short video clips to present on the external display. The system may apply the aforementioned methods to identify verbs and their subjects from the speech input. For example, if a verb is linked to the determined ambiguous object, the system may generate prompts containing the verb as well as the different object types. For instance, the system may determine that a speech input of “Apple is falling” may be referring to an apple falling from a tree or Apple Inc. stock price dropping. In this case, the system may identify “falling” as the verb and generate videos depicting an apple falling from a tree and a stock graph with a down-trending arrow.

FIG. 2 depicts a schematic illustration of system architecture 200 for generating content corresponding to an ambiguous term in speech, in accordance with some embodiments of this disclosure.

In some embodiments, user equipment 202 may comprise hardware modules 201 and processing modules 203 and may be connected to a communication network (e.g., communication network 215 and/or communication network 809 of FIG. 8) via a wireless or wired connection (e.g., I/O path 702 of FIG. 7 and I/O path 812 of FIG. 8). User equipment device 202 may comprise, for example, an XR device (e.g., user equipment 806 of FIG. 8), a personal computer (e.g., a notebook, a laptop, a desktop, user equipment 807 of FIG. 8), a smartphone (e.g., user equipment 700 of FIG. 7, and user equipment 808 of FIG. 8), a smartwatch, and/or a television (e.g., user equipment 810 of FIG. 8).

In some embodiments, user equipment hardware modules 201 comprise microphone 204, biometric sensors 206, internal display 216, and external display 222. In some embodiments, external display 222 is a device separate from but communicatively connected to user device 202. For example, the external display may comprise, for example, an external display of the user equipment 202, a display of a different user equipment (e.g., user equipment 806, 807, 808, and/or 810 of FIG. 8), or any combination thereof. Moreover, the separate external display may be connected to the user device 202 via a communication network (e.g., as described in further detail in FIG. 8). Microphone 204 may comprise, for example, a microphone array with noise cancelling features. Biometric sensors 206 may comprise, for example, electrodes, optical emitters and detectors, microphones, thermometers, thermistors, pressure sensors, respiratory sensors, eye-tracking sensors, video oculography (VOG) systems, facial tracking systems, infrared cameras, thermal cameras, motion sensors, pulse oximeters, ultrasonic sensors, voice-prosody analyzers, or other suitable sensor, or any combination thereof. Internal display 216 may comprise, for example, a private or personal screen (e.g., on an internal display of an HMD, a user device, or any suitable personal display). In one embodiment, user equipment 202 comprises an onboard processor or edge device to execute real-time speech recognition, ambiguity detection, and partial image generation tasks. In one embodiment, user equipment 202 comprises local and/or remote storage (e.g., storage circuitry 708 of FIG. 7, storage circuitry 814 of FIG. 8, or any other suitable storage) to store BCI data, mood data, ambiguity interpretation selections, and/or system usage data to refine future disambiguation.

In some embodiments, user equipment processing modules 203 comprise speech recognition module 208, multimodal fusion module 210, language understanding and ambiguity module 212, generative model module 214, user interface (UI) logic and feedback module 218, and adaptive learning module 220. In some embodiments, processing modules 203 may be part of a server (e.g., server 804 of FIG. 8) or a cloud computing environment connected to user equipment 202 through communication network 215 for computationally heavy generative Al tasks (e.g., large diffusion models, text-to-image, text-to-video, etc.).

In some embodiments, user equipment 202 comprises an HMD system. For example, the HDM system receives a speech input through data or recordings of microphone 204, and multimodal signals (e.g., mood data, BCI data, eye-tracking data, etc.) via biometric sensors 206, to generate visual content. As an example, the speech data from microphone 204 is transmitted to speech recognition module 208 for signal processing (e.g., filtering, normalization, feature extraction, etc.) and conversion of the filtered voice input to text (e.g., employing a deep-learning automatic speech recognition (ASR) system). The speech recognition module 208 may comprise a pre-trained language model (e.g., BERT, GPT-based embeddings, etc.) and process voice inputs to represent semantic content and contextual relationships of the words determined in the voice input. The speech recognition module 208 relays feature extractions (e.g., contextual relationships, vocal prosody (e.g., (pitch, volume, and speaking rate), etc.) and the converted text to the language understanding and ambiguity module 212, where the system determines whether the voice input may have multiple meanings (e.g., is determined to be ambiguous).

In a parallel path to the speech processing at the speech recognition module 208, the biometric signals from biometric sensors 206 are transmitted to multimodal fusion module 210 for signal processing (e.g., noise removal, filtering, normalization, feature extraction, collecting connectivity metrics, etc.) and to determine a cognitive state (e.g., increased attention or recognition), to determine an emotional state (e.g., calm, excited, stressed, nervous, positive, negative, etc.), to identify a particular attributes of an ambiguous term (e.g., color, style, texture, shape, size, etc.), and/or identify correlations of the biometric signals and phonemes and/or semantic cues. The output (e.g., generated text, latent representations (e.g., feature vectors), word embeddings, classification labels, probability distributions, confidence scores, etc.) of the multimodal fusion module 210 is transmitted to the language understanding and ambiguity module 212.

In some embodiments, the language understanding and ambiguity module 212 may combine the received outputs from speech recognition module 208 and multimodal fusion module 210 to determine whether multiple interpretations exist for each word or phrase of the voice input. For example, the language understanding and ambiguity module 212 may comprise, for example, a tokenizer (e.g., Byte-Pair Encoding, WordPiece, etc.), and a semantic parser that uses either a large language model (e.g., BERT, GPT-based, a custom domain-specific model, etc.) and/or a set of rules to identify key terms. Furthermore, the language understanding and ambiguity module 212 may use the outputs of the multimodal fusion module 210, lexical analysis, language modeling, and contextual cues to determine a probability score, confidence score, or correlation score for each interpretation found in the vector embeddings or data structure of the model. For example, vector embeddings are numerical representations of data in a continuous vector space used to encode complex data (e.g., words, images, patterns, behaviors, etc.) as embeddings, where embeddings with similar meanings or relationships are closer in the vector space. In some embodiments, the model may represent embeddings as vectors, matrices, tensors, or any other suitable mathematical form. The language understanding and ambiguity module 212 then determines, based on the probability score, confidence score, or correlation score for each interpretation (e.g., alternative processes 300, 330, and 360 of FIGS. 3A-C, respectively), one or more prompts to input into the generative model module 214 (e.g., Stable Diffusion, DALL-E, a custom-trained diffusion model, and/or any other suitable generative AI service, application, and/or model). For example, the language understanding and ambiguity module 212 prompt may include references to resolution, format, style, color, context, emotional state, etc. (e.g., “Generate a hyper-realistic image of a bright red apple”).

In some embodiments, the language understanding and ambiguity module 212 generates a prompt to input into the generative model module 214 (e.g., step 345 of process 330 of FIG. 3B) to generate for display a visual on external display 222. For example, when the language understanding and ambiguity module 212 determines that an interpretation has a confidence score greater than a configurable threshold (e.g., 80%) the language understanding and ambiguity module will generate a prompt to generate a visualization on an external display. In some embodiments, the system may generate a visual on the external display at a high resolution, a scaled-up representation, or in higher computational and/or quality formats (e.g., higher-resolution images, videos, audio, etc.). In some embodiments, a single multimodal neural network (e.g., generative model module 214) may directly determine the visual output based on the voice input, BCI signals, and mood signals.

In some embodiments, the language understanding and ambiguity module 212 generates more than one prompt to input into the generative model module 214 (e.g., step 315 of process 300 of FIG. 3A and/or step 375 of process 360 of FIG. 3C) to generate for display visual options on internal display 216 for selection prior to a generation for display on external display 222. The system generates options on internal display 216 to acknowledge confidence scores of interpretations of the ambiguous word or phrase that are less than a configurable threshold (e.g., 80%) and provide visual options for private feedback to prevent miscommunication from generating a single best-guess visual representation (e.g., selecting the highest probability score only, regardless of a low confidence). In some embodiments, the system conserves computational resources by generating these visual options at a low resolution, in a scaled-down version, or in lower computational and/or quality formats (e.g., text, lower resolution images, . gif image files, etc.). For example, a UI manager of the system may divide the field of view of the HMD into regions, according to the number of candidate visual interpretations, each showing one candidate.

In some embodiments, the system may employ methods to reduce latency for generating visual representations for ambiguous word or phrase interpretations. For example, the system may supplement user equipment 202 with edge computing or a cloud-based generative server connected through communication network 215. In another example, the system may implement a queue-based architecture enabling the user equipment 202 to send generation requests to a server (e.g., server 804 of FIG. 8) that provide streaming partial results (e.g., progressive renderings) or an entire set of low-resolution previews. During the transmission of the results, the user equipment 202 may display thumbnails to indicate the pending results. In another example, the system may implement an optimized pipeline (e.g., TensorRT for NVIDIA, Core ML for Apple hardware, etc.) to expedite inferencing.

In some embodiments, the system receives biometric signals from biometric sensors 206 to determine a selection of a visual option (e.g., step 321 of process 300 of FIG. 3A). For example, an eye-tracking and interaction manager of the system may monitor for a user gaze vector (e.g., the direction that a user's eyes are pointed or focused) using near-infrared cameras that reflect off of the user's cornea to determine the line of sight. The system may record dwell time on each visual region corresponding to a displayed visual interpretation. In one embodiment, the system may determine a selection of a displayed visual interpretation upon determining that a user gaze vector dwell time exceeds a configurable threshold (e.g., 200 milliseconds). In some embodiments, the system may determine a selection of a displayed visual interpretation upon determining a displayed visual interpretation of the candidate displayed visual interpretations with the longest or threshold dwell time. In certain embodiments, a classifier can be trained, based on the eye gaze vectors, to determine a selection of a displayed visual interpretation. In some embodiments, the system may receive BCI data and/or mood data to confirm or reject a selection suggested by the eye-tracking correlation. In some embodiments, the system may accept or reject a selection directly based on BCI data and/or mood data. For example, the BCI data and/or mood data may be correlated with the term “red apple.” In some embodiments, the system may receive data from a gesture (e.g., head movement, head gaze, head tilt, hand gesture, etc.) correlating to the region of one of the displayed visual interpretations to navigate and/or select. For example, the system may determine a head gaze (e.g., direction that a user's head is pointing), through one or more inertial measurements sensors (e.g., gyroscopes, accelerometers, magnetometers, etc.) and/or cameras (e.g., internal or external). In some embodiments, the system may receive data from a button, touchscreen, or controller of user equipment 202 to navigate and/or select. In some embodiments, when the system determines that a selection of a displayed visual interpretation has been made, the system may provide a visual indicator to indicate that selection. For example, the system may show a checkmark overlaid on the selected visual interpretation, a greyed out checkmark on unselected visual interpretations, an animation for the selected visual interpretation (e.g., the selected visual interpretation enlarges, the unselected visual interpretations disappear, etc.), a visual effect (e.g., colorizing/decolorizing visual interpretations), a haptic effect (e.g., vibration from vibration motors), an audible signal (e.g., sounds corresponding to selection, sounds corresponding to no selection, or words describing the same), or any combination thereof. The system transmits the selection to the UI logic and feedback module 218.

In some embodiments, e.g., when the system cannot determine a clear selection of the displayed visual interpretations, the system may provide additional visual indicators (e.g., tooltips, textual captions, audio descriptions, etc.). For example, the system may determine no selection when recorded dwell times are less than a configurable threshold (e.g., 200 milliseconds) for all candidate visual interpretations. In another example, the system may determine no selection when the system determines unstable user gaze vectors (e.g., user gaze vectors continually move between the visual interpretations). For instance, the system may display visual options for the ambiguous word “apple” and display an image of fruit on the left-hand side of an HMD display and an image of a company logo on the right-hand side of an HMD display. Once the system determines that the user gaze vectors indicate no selection (or, in some embodiments, if the system receives BCI or mood signals indicating confusion), the system may display textual captions for each visual interpretations (e.g., “This is a green apple,” “This is the Apple Inc. logo,” etc.)

In some embodiments, e.g., when the system cannot determine a clear selection of the displayed visual interpretations, the system may provide a visual indicator to indicate that a selection has not been made. For example, the system may apply screen effects (e.g., blinking) to provide an alert to select a displayed option. In another example, the system may display an icon or a message to indicate that a selection has not been made. In some embodiments, based on microphone, biometric sensor, or other user equipment input, the system may adjust the regions of the displayed visual interpretations in order for one of the displayed visual interpretations to be presented as larger, more prominent, or in/with more detail for feedback and selection.

In some embodiments, the UI logic and feedback module 218 relays the results of the selection (e.g., selected visual interpretation, unselected visual interpretation, mood data, BCI data, etc.) to the adaptive learning module 220. For example, the adaptive learning module 220 may may store the ambiguity options, the option selection, BCI data, mood data, and system usage data. The adaptive learning module 220 may refine probability distributions, incorporate historical context (e.g., selection patterns), refine or retrain the language understanding and ambiguity model 212, and/or refine or retrain the generative model module 214, etc., to adapt the system according to user-specific preferences, situational context, and domain-specific context of resolved ambiguities. Thus, the adaptive learning module 220 refines future resolution strategies and reduces system resources for repeat ambiguities.

In some embodiments, the UI logic and feedback module 218 receives the selection of the displayed visual interpretation and, based on the selection and the biometric data collected during the selection, generates an updated enriched text prompt (e.g., more detailed than the prompt for the plurality of candidate options) to input into generative model module 214.

In some embodiments, generative model module 214 generates for display the selected visual option on an external display 222. For example, the external display may be an external display of the user equipment 202, a display of a different user equipment (e.g., user equipment 806, 807, 808, and/or 810 of FIG. 8), or any combination thereof. In some embodiments, the system may generate a visual on the external display in a high-resolution, in a scaled-up version, or in higher computational and/or quality formats (e.g., higher-resolution images, videos, audio, etc.). In some embodiments, a single multimodal neural network (e.g., generative model module 214) may directly determine internal and external visual outputs based on the voice input, BCI signals, and mood signals.

In some embodiments, the system may be configured as a standalone generative AI application. For example, the standalone generative AI application may be developed for personal computers (e.g., a notebook, a laptop, a desktop, user equipment 807 of FIG. 8), smartphones (e.g., user equipment 700 of FIG. 7, and user equipment 808 of FIG. 8), smartwatches, televisions (e.g., user equipment 810 of FIG. 12), or any other suitable computing device. The system may comprise, for example, a combination of built-in and connected microphones, biometric sensors, and displays. For example, this embodiment may be used as a tool for creating AI-generated arts (e.g., digital art creation, content generation, interactive storytelling, etc.).

In some embodiments, the system may be configured across a plurality of user equipment (e.g., several of user equipment 202) to facilitate clear communication in a collaborative environment. For example, in this configuration, the system may be utilized for virtual meetings, brainstorming sessions, or collaborative design projects. As an example, one or more devices in the collaborative system may determine that a speech input contains an ambiguous term. The system then provides each device visual options of the ambiguous term on the internal display of each device for selection. The system may collect direct selections (e.g., eye gaze tracking or any suitable selection method) of the visual options on each device for a consensus vote (e.g., the option with the greatest number of selections or the option that is greater than a configurable threshold is selected), or may record and process speech input, BCI data, and/or mood data from discussions of the displayed visual options to determine a selection.

In an embodiment, the system may be used to enhance events and performances by generating real-time visualizations. For example, the system may be configured using multiple devices (e.g., several of user equipment 202) for theater productions, live streaming, or interactive exhibitions. To illustrate, the system may determine that the speech input from an actor during a live performance contains the ambiguous term “dragon,” which may be interpreted as a traditional Western dragon or an Eastern dragon. In one embodiment, multiple user devices in the audience may be used to privately select a preferred embodiment and generate for display a visual stage backdrop, projection onto external screens, AR overlays within the venue, or props in real time. In an embodiment, the system may generate the visual options on a single display (e.g., stage backdrop) and determine audience selection using the multiple user devices to determine visual option selection (e.g., via eye gaze, BCI data, mood data, gesture, etc.) for generating for display a visual stage backdrop, projection onto external screens, AR overlays within the venue, or props in real time.

FIGS. 3A-C depict sequence diagrams for generating content corresponding to an ambiguous term, in accordance with some embodiments of this disclosure. In various embodiments, steps of processes 300, 330, and 360 are corresponding. For example, step 301 of FIG. 3A may generally correspond with steps 331 of FIG. 3B, and 361 of FIG. 3C. Accordingly, upon identical or substantially similar steps, correspondence is indicated (details of identical or substantially similar steps are omitted for brevity). In various embodiments, the individual steps of sequence diagrams 300, 330, and 360 may be implemented by one or more components of the devices, systems, and/or methods of FIGS. 1-8 and may be performed in combination with any of the other processes and aspects described herein. Although the present disclosure may describe certain steps of sequence diagrams 300, 330, and 360 (and of other processes described herein) as being implemented by certain components of the devices, systems, and/or methods of FIGS. 1-8, this is for purposes of illustration only. It should be understood that, e.g., other components of the devices, systems and methods of FIGS. 1-8 may implement those steps instead.

FIG. 3A depicts a sequence diagram 300 for generating content corresponding to an ambiguous term when confidence is below a threshold, in accordance with some embodiments of this disclosure.

In some embodiments, at 301, microphone 306 receives a voice input containing an ambiguous term. For example, the system may receive the voice input containing the polysemous term “Samba dancer.”

In some embodiments, at 303, biometric sensors 304 receive a biometric signal. Biometric sensors 304 may comprise, for example, electrodes, optical emitters and detectors, microphones, thermometers, thermistors, pressure sensors, respiratory sensors, eye-tracking systems, VOG systems, facial tracking systems, infrared cameras, thermal cameras, motion sensors, pulse oximeters, ultrasonic sensors, and/or any combination thereof or other suitable biometric sensor. For example, the biometric sensors may receive a biometric signal at a time point substantially simultaneous to the microphone 306 receiving the voice input. The BCI signal may comprise, for example, electroencephalogram (EEG) signals, and/or functional near-infrared spectroscopy (fNIRS) signals, etc.). The mood signal may comprise, for example, voice characteristics (e.g., vocal prosody including pitch, volume, and speaking rate), physiological signals (e.g., heart rate, galvanic skin response (GSR) measurements, skin temperature, respiratory rate, blood pressure, pupil dilation, body posture changes, blood oxygen level, etc.), facial electromyography (fEMG) signals, camera-captured facial expression signals, etc.), or any combination thereof.

In some embodiments, at 305, the system control circuitry (e.g., control circuitry 704 of FIG. 7 and/or control circuitry 811 of FIG. 8), and/or I/O circuitry (e.g., I/O circuitry 702 of FIG. 7 and/or I/O circuitry 812 of FIG. 8) may process the BCI signals and mood signals to remove noise (e.g., through independent component analysis (ICA), filtering for frequency bands relevant to semantic processing or recognition (e.g., via bandpass filtering (e.g., 1-50 Hz)), normalization, etc.), extract features (e.g., time-frequency features such as power in delta, theta, alpha, beta, and gamma bands for BCI signals, and mel-frequency cepstral coefficients (MFCC) and gamma-tone cepstral coefficients (GTCCs) for properties of speech for mood signals, etc.), and collect connectivity metrics (e.g., measurements of the synchronization between EEG channels). For example, the system control circuitry may extract event-related potentials (ERPs) reflect semantic processing from an EEG signal (e.g., N400) to identify a particular attribute. In another example, the system control circuitry may compute power spectral density in relevant frequency bands (e.g., delta, theta, alpha, beta, gamma, etc.) to determine specific cognitive states (e.g., increased attention or recognition). The system may relay the processed signal as biometric data to the NLU & ambiguity module 310.

In some embodiments, at 307 and 309, the control circuitry and/or I/O circuitry of speech recognition module 308 may process the voice input. For example, at 307, the control circuitry may filter the voice input to remove background noise, normalize the voice input in amplitude, and perform feature extraction (e.g., MFCCs) to generate semantic representations of the words or phrases on the voice input as embeddings. For example, MFCCs capture low-level, timbral properties of speech and may track intonation shifts that indicate emphasis or intent. In some embodiments, the speech recognition module 308 may utilize a pre-trained language model (e.g., BERT, GPT-based embeddings, etc.) to represent semantic content and contextual relationships of the word(s) or phrases(s) determined in the voice input. The speech recognition module 308 of the system, at 309, then converts the filtered voice input to text.

In some embodiments, at 311, the transcribed text from the speech recognition module 308 is relayed to the NLU & ambiguity module 310.

In some embodiments, at 313, the NLU & ambiguity module 310 control circuitry processes the biometric data and the transcribed text to determine any ambiguous terms or phrases in the voice input 301.

For example, the NLU & ambiguity module 310 of the system may comprise a tokenizer (e.g., Byte-Pair Encoding, WordPiece, etc.), and a semantic parser that uses either a large language model (e.g., BERT, GPT-based, a custom domain-specific model, etc.) and/or a set of rules to identify key terms. In some embodiments, the system may maintain a dictionary and/or database of potentially ambiguous words and phrases (e.g., “apple,” “jaguar,” “bank,” etc.) stored in a data structure in the system memory (e.g., in storage circuitry 708 of FIG. 7, storage circuitry 814 of FIG. 8, or any other suitable storage). For example, each ambiguous word or phrase in the data structure is associated with a set of possible interpretations and metadata for each interpretation (e.g., classification, type, stock symbol, corresponding mood signals, corresponding BCI signals etc.). For instance, the ambiguous word “apple,” is stored in association with interpretations and corresponding metadata: “red apple” (fruit, red delicious, 6-10cm, smooth, sweet, fall, etc.), “green apple” (fruit, Granny Smith, 6-9 cm, smooth, tart, fall, etc.), and “Apple Inc.” (brand, technology, Steve Jobs, AAPL, iOS, iPhone, etc.).

In a further example, the system may be trained in specific domains by incorporating domain-specific dictionaries and contextual models within the NLU & ambiguity module 310. As an example, in medical applications, the system may be integrated into AR glasses used by healthcare professionals. In this example, the system may generate visual interpretations related to different medical scenarios or equipment received as a speech input. The system may prioritize interpretations based on the clinical context (e.g., patient history, ongoing procedures, etc.). In educational applications, as another example, the system may generate visualizations to clarify complex concepts. For instance, the system may determine a subject matter related to an ambiguous science term, for example “cell,” and determine visualization options for a battery cell and a biological cell for feedback selection to tailor visual aids during a lecture. Additionally, for example, the system may integrate with design software of design and creative industries to generate multiple interpretations for designs or creations from speech input. As an example, the system may generate various stylistic designs (e.g., minimalist, ergonomic, avant-garde, etc.) of ambiguous descriptions (e.g., “modern chair”) and adjust to user preferences through refinement using recorded selections over time.

In another example, the system may be trained using customized or personalized ambiguity dictionaries. For example, the system may maintain detailed user profiles to weight ambiguity resolution based on individual preferences and/or specialized vocabularies. In some embodiments, the system may enable input to add custom terms, specify preferred interpretations for certain ambiguous words, and adjust confidence thresholds. For example, if the system is used in graphic design, the system may be configured to prioritize artistic interpretations of terms (e.g., “abstract” as in the adjective rather than the noun). While if the system is used in finance, the system may be configured to prioritize business-related meanings. The system may store these configurations and preferences in user profiles, which may be synchronized across multiple devices through a same account on cloud services.

In some embodiments, the NLU & ambiguity module 310 may compare the transcribed text and biometric data to the data structure to determine whether multiple interpretations exist for each word or phrase of the voice input. Furthermore, the NLU & ambiguity module 310 may use the BCI data or mood data to determine a probability score, confidence score, or correlation score for each interpretation found in the vector embeddings or data structure of the model. For example, vector embeddings may comprise, for example, numerical representations of data in a continuous vector space used to encode complex data (e.g., words, images, patterns, behaviors, etc.) as embeddings, where embeddings with similar meanings or relationships are closer in the vector space. In some embodiments, the model may represent embeddings as vectors, matrices, tensors, or any other suitable mathematical form. In some embodiments, based on the confidence score, the NLU & ambiguity module 310 may reduce the number of candidate interpretations to only those meeting a threshold confidence score (e.g., greater than 50%) and/or generate candidate visual options for the candidate visual options on an internal display (e.g., process 300). In some embodiments, based on the confidence score, the NLU & ambiguity module 310 may select a candidate interpretation that passes a threshold confidence score (e.g., 90%) to generate a visual representation on an external display (e.g., process 330). In some embodiments, based on the confidence score, the NLU & ambiguity module 310 may determine a candidate interpretation passes a threshold confidence score (e.g., 90%), determine the candidate interpretation has additional attribute ambiguities (e.g., color, style, texture, shape, size, etc.), and generate candidate visual options for the attribute ambiguities of the candidate interpretation on an internal display (e.g., process 360).

In some embodiments, the NLU & ambiguity module 310 is a context-based neural classifier that receives the biometric data and voice input directly to determine whether multiple interpretations exist for each word or phrase of the voice input.

For instance, returning to the “Samba dancer” example, the system NLU & ambiguity module 310 may determine the polysemous phrase, “Samba dancer,” from the voice input and determine a plurality of interpretations exist including: a traditional carnival Samba dancer in full festive costume, a modern dance studio scene (e.g., a casual dancer performing Samba steps indoors), and a stylized cartoon character dancing Samba. The NLU & ambiguity module 310 may map the extracted features from the collected BCI signals and mood signals to an emotional state or an excitement indicator corresponding to stress or excitement levels using an existing data structure and/or through a neural network (e.g., a trained classifier that correlates the extracted features with vector embeddings of the trained classifier). For example, the system may determine that the mood signals, at the time of the speech input, correspond to excitement during a positive emotional state (e.g., emotions that may be associated with lively performances and bright visuals). The system may further determine that the BCI patterns, at the time of the speech input, have higher correlation with outdoor, festival-like scenes as compared to indoor or cartoonish imagery. The system may use the emotional state, the excitement indicator, or embeddings correlated to the emotional state and/or excitement indicator to determine a weight for each interpretation based on a probability score, confidence score, or correlation score of the extracted features and the vector embeddings or data structure. For example, the system weights the three interpretations using the determinations from the BCI signals and the mood signals and further determines that the stylized cartoon interpretation is below a configurable confidence threshold (e.g., below 50%, 42%, etc.) and therefore, not likely enough to be the intended interpretation and removes the interpretation from the candidates.

In some embodiments, at 315, the NLU & ambiguity module 310 generates prompts for candidate visual options for each ambiguous term interpretation. For example, in some embodiments, the NLU & ambiguity module 310 is a deep-learning model (e.g., a transformer with specialized attention layers for multimodal data) that may fuse the extracted BCI data (e.g., EEG), extracted mood data, and speech features to generate enriched text outputs for each interpretation. The prompts from the NLU & ambiguity module 310 are relayed to the generative AI model 312.

Returning to the “Samba dancer” example, the remaining interpretations may have a confidence score below a confidence score threshold (e.g., 80%) for external generation and proceed to generating the candidate visual options for the user display 302. For example, the system may determine the traditional carnival Samba dancer in full festive costume and the modern dance studio scene each have a confidence score below the configurable confidence score threshold. In response, the system, utilizing a deep-learning model (e.g., the NLU & ambiguity module 310), will proceed to generate enriched text prompts for each candidate visual option based at least in part on the extracted features from the collected BCI signals and mood signals (e.g., “Generate a low-resolution image of a traditional carnival Samba dancer in full festive costume during a lively outdoor festival-like performance with bright visuals and excitement.”).

In some embodiments, at 317, the generative AI 312 (e.g., Stable Diffusion, DALL-E, a custom-trained diffusion model, and/or any other suitable generative AI service, application, and/or model) generates for display candidate visual options on the user display 302 (e.g., internal display of HMD, or any suitable personal display). For example, candidate visual options may be displayed so they are distributed horizontally (e.g., one on the left-hand side, one on the right hand side, and, if more than two, the other options in the middle), vertically (e.g., one on the top, one on the bottom, and, if more than two, the other options in the middle), or any distribution of the candidate options on the internal display that allows the system to determine a selection of one of the candidate visual options. In some embodiments, the internal display images are generated at a low resolution or scaled-down version to minimize resources for intermediate renderings of the visual options.

In the “Samba dancer” example, the system may input the NLU & ambiguity module prompts into a generative model to generate for display, on the internal display of an HMD, each of the remaining candidate visual options (e.g., a bustling street carnival dancer on the left-hand side of the display and a stage performer in a decorated ballroom on the right-hand side of the display).

In some embodiments, at 319 and 321, the system may determine a selection of a candidate visual option through the biometric sensors 304. For example, the system may receive data from an eye-tracking sensor, cameras inside and/or outside of the device, and/or other sensors correlating to the direction of one of the displayed visual representations to navigate and/or select. In some embodiments, the system may receive BCI data and/or mood data to confirm or reject a selection suggested by the eye-tracking correlation. For example, if the system detects eye tracking correlated to selecting a visual option on the left-hand side, but the BCI data suggests the selection of the eye-tracked selection is incorrect, the system may reject that selection. For example, at the time of a selection, the system may reject the selection if the system detects a familiarity signal that suggests the person does not recognize the option, or determines the mood data, at the time of selection, indicates negative facial expressions (e.g., eyebrow furrowing, lip pursing, squinting, nostril flaring, etc.), increased skin conductance response (e.g., indicating emotional discomfort), erratic gaze patterns (e.g., increased blinking, shifting eye focus, longer reaction time, etc.), or any combination thereof. On the other hand, if the system detects eye tracking correlated to selecting a visual option on the left-hand side, and the BCI data suggests the selection of the eye-tracked selection is correct, the system may accept that selection. For example, at the time of a selection, the system may accept the selection if the system detects a familiarity signal that suggests the person does recognize the option, or determines the mood data, at the time of selection, indicates positive facial expressions (e.g., relaxed eyebrows, slight smile, etc.), stable skin conductance, stable gaze patterns (e.g., reduced blinking, eye focus, shorter reaction time, etc.), or any combination thereof. In some embodiments, the system may accept or reject a selection directly based on BCI data and/or mood data. For example, the BCI data and/or mood data may be correlated with the term “red apple.” In another example, the system may receive data from gesture recognition sensors (e.g., cameras inside and/or outside of the device, infrared sensors, etc.) of a gesture (e.g., head movement, head gaze, head tilt, hand gesture, sign language, etc.) to navigate and/or select. For example, the system may determine a selection by receiving data indicative of gesturing or pointing in a direction correlated to the direction of one of the displayed visual representations. In another example, the system may receive data from a button, touchscreen, or controller to navigate and/or select. In some embodiments, the system may generate an updated enriched text prompt (e.g., more detailed than the prompt of step 315), based on the selection and the biometric data collected during the selection.

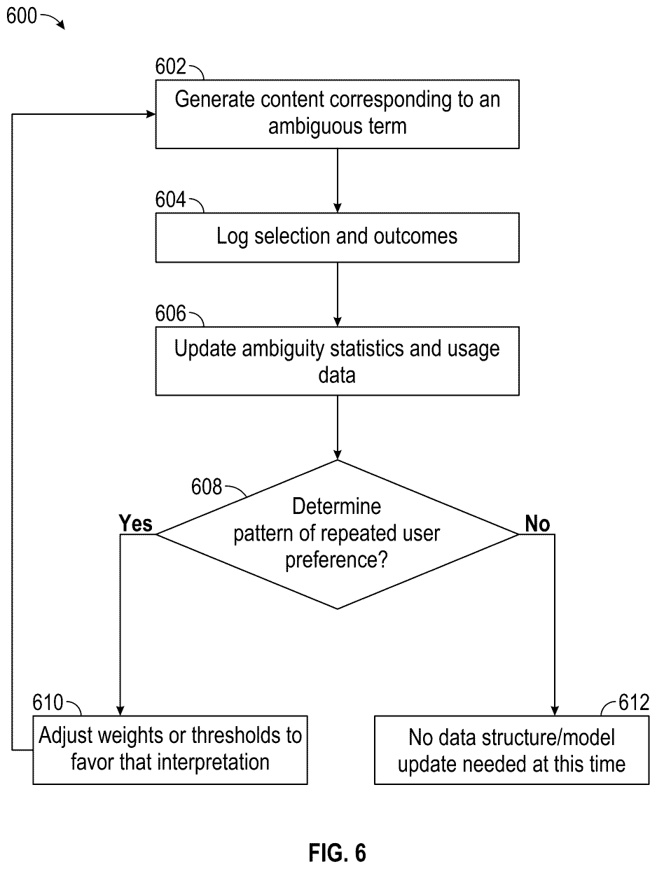

In some embodiments, the system may store the selection and update the data structure confidence scores and/or refine or retrain the neural network for future inferences (e.g., process 600 of FIG. 6).

In some embodiments, at 323, the system may, using the generative AI 312, generate for display the selected visual option on an external display 314. For example, the external display may be an external display of the HMD, an internal display of a different HMD, a different external display (e.g., phone display, computer display, watch display, tablet display, e-reader display, car display, television display, projection, or digital display), or any combination thereof. In some embodiments, the internal display images are generated at a low resolution or a scaled-down version, and the external display images are generated at a high-resolution or a scaled-up representation (e.g., 256×256 vs. 1024×1024). In some embodiments, the internal display visual options may be lower computational and/or quality representations (e.g., text, lower resolution images, gif image files, etc.), and the external display visual options may be higher computational and/or quality representations (e.g., higher resolution images, videos, audio, etc.). In some embodiments, a single multimodal neural network may directly determine the external visual output based on the voice input, BCI signals, and mood signals.

Returning to the “Samba dancer” example, the system may determine an eye gaze selection of the traditional carnival Samba dancer in full festive costume. In response to the selection, the system, utilizing a deep-learning model, will proceed to generate an enriched text prompt, based at least in part on the extracted features from the collected BCI signals and mood signals (e.g., “Generate a high-resolution video of a traditional carnival Samba dancer in full festive costume dancing during a lively outdoor festival-like performance with bright visuals and excitement from a large crowd.”). The system may input the prompt into a generative model to generate for display, on the external display of an HMD, a video of the traditional carnival Samba dancer in full festive costume dancing in front of a crowd at a festival.

FIG. 3B depicts a sequence diagram 330 for generating content corresponding to an ambiguous term when confidence is above a threshold, in accordance with some embodiments of this disclosure.

Steps 331-343 of FIG. 3B generally correspond with steps 301-313 FIG. 3A, respectively.

In some embodiments, at 345, the system may determine that a candidate interpretation passes a threshold confidence score (e.g., 90%) and the NLU & ambiguity module 310 may generate a prompt to generate a visual representation on an external display. For example, in some embodiments, the NLU & ambiguity module 310 is a deep-learning model (e.g., a transformer with specialized attention layers for multimodal data) that may fuse the extracted BCI data (e.g., EEG), extracted mood data, and speech features to generate enriched text outputs for each interpretation. The prompts from the NLU & ambiguity module 310 are relayed to the generative AI model 312.

In some embodiments, the system may determine that a candidate interpretation passes a threshold confidence score (e.g., 90%) but may have attribute ambiguities. For example, the system may determine “apple (fruit)” is correct, but the apple color is unknown. In this example, the system may determine the attribute directly based on BCI data and/or mood data. For example, the BCI data and/or mood data may be correlated with the term “red apple.”

In some embodiments, at 347, the system may, using the generative AI 312, generate for display the candidate interpretation, which passed the threshold confidence score, on an external display 314. For example, the external display may be an external display of the HMD, an internal display of a different HMD, a different external display (e.g., phone display, computer display, watch display, tablet display, e-reader display, car display, television display, projection, or digital display), or any combination thereof. In some embodiments, the external display visual may comprise higher computational and/or quality representations (e.g., higher resolution images, videos, audio, etc.). In some embodiments, a single multimodal neural network may directly determine the external visual output based on the voice input, BCI signals, and mood signals.

In the “Samba dancer” example, the system may determine the traditional carnival Samba dancer in full festive costume has a 95% confidence score. In response, the system, utilizing a deep-learning model, will proceed to generate an enriched text prompt, based at least in part on the extracted features from the collected BCI signals and mood signals (e.g., “Generate a high-resolution video of a traditional carnival Samba dancer in full festive costume dancing during a lively outdoor festival-like performance with bright visuals and excitement from a large crowd.”). The system may input the prompt into a generative model (e.g., Stable Diffusion, DALL-E, a custom-trained diffusion model, and/or any other suitable generative AI service, application, and/or model) to generate for display, on the external display of an HMD, a video of the traditional carnival Samba dancer in full festive costume dancing in front of a crowd at a festival.

In some embodiments, the system may be integrated with external data sources and application programming interfaces (APIs) to enhance ambiguity resolution through real-time contextual information. For example, the system may be connected to, and pull data from, a calendar, photo album, social media account, location service, etc. to utilize as context when determining interpretations for an ambiguous term (e.g., step 313 of FIG. 3). For example, the system may receive the ambiguous term “apple” and determine from location services and a social media account that the device is at a technology conference and, therefore, prioritize an “Apple Inc.” interpretation. In another example, the system may refine the accuracy of visual interpretations by integrating trending topics of user interactions from social media accounts.

In one embodiment, the system may determine that a word or phrase, ambiguous or not, in the speech input corresponds to metadata of a media content item (e.g., image, video, audio, text) stored locally or remotely (e.g., storage circuitry 708 of FIG. 7, storage circuitry 814 of FIG. 8, etc.). For example, the system may determine a high confidence score that a media content item has been referenced and retrieves the media content item from storage to display.

For instance, the system may receive the speech input “I saw the wave for the first time!” and determine a recent video of a crowd at a stadium doing the wave is available to retrieve from storage and display. In some embodiments, the system may be configured to directly display the media content item on the external display. In other embodiments, the system may be configured to display the media content item on the internal display for confirmation prior to external display.

FIG. 3C depicts a sequence diagram 360 for generating content corresponding to an ambiguous term when confidence is above a threshold with attribute enhancement, in accordance with some embodiments of this disclosure. As an example, the NLU & ambiguity module 310 may determine a term is ambiguous with respect to potential attributes of the term. For example, the NLU & ambiguity module 310 may have a high confidence score (e.g., 95%) that a received term, “apple,” means the fruit. However, “apple” as the fruit may have more than one color or style (e.g., Red Delicious, Granny Smith, etc.). Therefore, the NLU & ambiguity module 310 may determine attributes (e.g., color, style, texture, shape, size, etc.) of the ambiguous term (e.g., “apple”) to generate candidate visual options for selection.

Steps 361-373 of FIG. 3C generally correspond with steps 301-313 FIG. 3A, respectively.

In some embodiments, the NLU & ambiguity module 310 may determine attributes of the ambiguous term while processing transcribed text in step 373 to utilize as guides or limits for visual option generation. For example, the NLU & ambiguity module 310 may store predefined attributes or traits (e.g., color, style, texture, shape, size, etc.) related to ambiguous term interpretations that may be populated and used for prompt generation based on the speech input. For example, if the system receives the speech input, “I love to eat an apple after lunch,” the system may generate an image of a generic apple. If, however, the system receives the speech input, “I love to eat a little red apple after lunch,” the system may identify that apple color and size attributes have been identified and include those traits in the image generation prompt. In another examples, the system may receive a speech input that identifies a size attribute (e.g., “an enormous apple”), and the system may generate an image that contains the described object as well as other objects as points of comparison. For example, in this case the NLU & ambiguity module 310 prompt for image generation may comprise, for example, “Include a softball next to the enormous apple.”

In some embodiments, at 375, the NLU & ambiguity module 310 generates prompts for attribute visual options for the ambiguous term. For example, in some embodiments, the NLU & ambiguity module 310 is a deep-learning model (e.g., a transformer with specialized attention layers for multimodal data) that may fuse the extracted BCI data (e.g., EEG), extracted mood data, and speech features to generate enriched text outputs for each interpretation. For example, one prompt may be “Generate a description for a Red Delicious apple,” and a second prompt may be, e.g., “Generate a description for a Granny Smith apple.” The prompts from the NLU & ambiguity module 310 are relayed to the generative AI model 312.

In some embodiments, at 377, the generative AI 312 (e.g., Stable Diffusion, DALL-E, a custom-trained diffusion model, and/or any other suitable generative AI service, application, and/or model) generates for display attribute visual options on the user display 302 (e.g., internal display of HMD, or any suitable personal display). For example, candidate visual options may be displayed so they are distributed horizontally (e.g., one on the left-hand side, one on the right hand side, and, if more than two, the other options in the middle), vertically (e.g., one on the top, one on the bottom, and, if more than two, the other options in the middle), or any distribution of the candidate options on the internal display that allows the system to determine a selection of one of the attribute visual options. In some embodiments, the internal display images are generated at a low resolution or scaled-down representation to minimize resources for intermediate renderings of the visual options.

For example, the generative AI 312 may access the data structure associated with the set of possible interpretations and metadata for each interpretation or may use vector embeddings to generate for display an output for the attribute prompts, on the internal display of an HMD. For example, the first corresponding output may be “The Red Delicious apple is a smooth, crimson fruit, 6-10 cm in height. With a sweet flavor and crisp texture, it's a classic fall harvest favorite.” and a second corresponding output may be “The Granny Smith apple is a smooth, green fruit, 5-9 cm in height, known for its crisp texture and tart flavor. Harvested in the fall, it's perfect for fresh eating, baking, and cider-making.”

In some embodiments, at steps 379 and 381, the system may receive and determine a selection of an attribute visual option through the biometric sensors 304. For example, the system may receive data from an eye-tracking sensor, cameras inside and/or outside of the device, and/or other sensors correlating eye gaze (e.g., the direction that a user's eyes are pointed or focused) to the direction of one of the displayed visual representations to navigate and/or select. In some embodiments, the system may receive BCI data and/or mood data to confirm or reject a selection suggested by the eye-tracking correlation. For example, if the system detects eye tracking correlated to selecting a visual option on the left-hand side, but the BCI data, at the time of selection, indicates a familiarity signal that suggests the person does not recognize the option, and/or the system determines that the mood data, at the time of selection, indicates negative facial expressions (e.g., eyebrow furrowing, lip pursing, squinting, nostril flaring, etc.), increased skin conductance response (e.g., indicating emotional discomfort), erratic gaze patterns (e.g., increased blinking, shifting eye focus, longer reaction time, etc.), or any combination thereof that suggests the selection of the eye-tracked selection is incorrect, the system may reject that selection. On the other hand, if the system detects eye tracking correlated to selecting the visual option on the left-hand side, and the BCI data, at the time of selection, indicates a familiarity signal that suggests the person does recognize the option, and/or the system determines that the mood data, at the time of selection, indicates positive facial expressions (e.g., relaxed eyebrows, slight smile, etc.), stable skin conductance, stable gaze patterns (e.g., reduced blinking, eye focus, shorter reaction time, etc.), or any combination thereof that suggests the selection of the eye-tracked selection is correct, the system may accept that selection. In some embodiments, the system may accept or reject a selection directly based on BCI data and/or mood data. For example, the BCI data and/or mood data may be correlated with the term “red apple.” In some embodiments, the system may receive data from a gesture (e.g., head movement, head gaze, head tilt, hand gesture, etc.) correlating to the region of one of the displayed visual interpretations to navigate and/or select. For example, the system may determine a head gaze (e.g., direction that a user's head is pointing), through one or more inertial measurements sensors (e.g., gyroscopes, accelerometers, magnetometers, etc.) and/or cameras (e.g., internal or external). In some embodiments, the system may receive data from a button, touchscreen, or controller to navigate and/or select. In some embodiments, the system may generate an updated enriched text prompt (e.g., more detailed than the prompt of step 375), based on the selection and the biometric data collected during the selection.

In some embodiments, the system may store the selection and update the data structure confidence scores and/or refine or retrain the neural network for future inferences.

In some embodiments, at step 383, the system may, using the generative AI 312, generate for display the selected visual option on an external display 314. For example, the external display may be an external display of the HMD, an internal display of a different HMD, a different external display (e.g., phone display, computer display, watch display, tablet display, e-reader display, car display, television display, projection, or digital display), or any combination thereof. In some embodiments, the internal display images are generated at a low resolution or a scaled-down representation, and the external display images are generated at a high-resolution or a scaled-up representation (e.g., 256×256 vs. 1024×1024). In some embodiments, the internal display visual options may be lower computational and/or quality representations (e.g., text, lower resolution images, gif image files, etc.), and the external display visual options may be higher computational and/or quality representations (e.g., higher resolution images, videos, audio, etc.). In some embodiments, a single multimodal neural network may directly determine the external visual output based on the voice input, BCI signals, and mood signals.

For example, the system may determine an eye gaze selection of the Granny Smith descriptive text. In response to the selection, the system, utilizing a deep-learning model, will proceed to generate enriched text prompts, based at least in part on the extracted features of the from the collected BCI signals and mood signals (e.g., “Generate a high-resolution image of a Granny Smith apple in front of an apple pie.”). The system may input the prompt into a generative model to generate for display, on the external display of an HMD, a high-definition image of a Granny Smith apple in front of an apple pie.

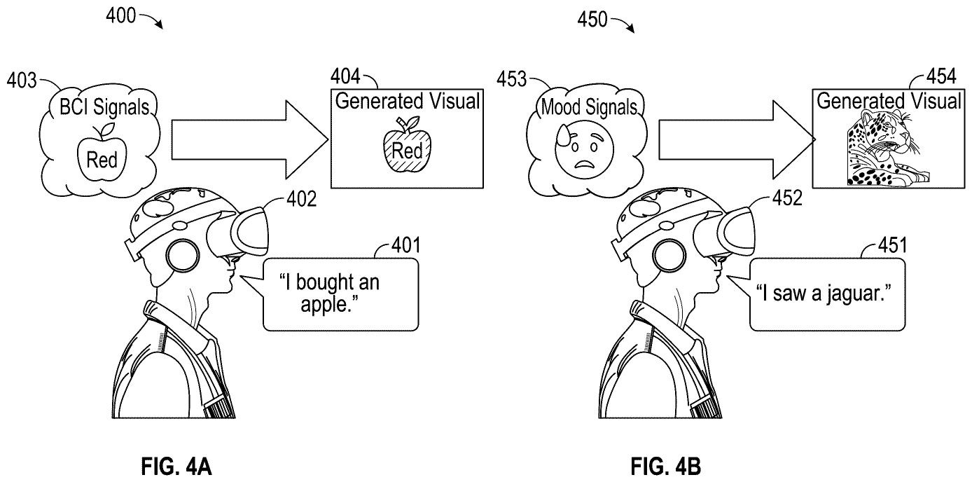

FIG. 4A depicts a schematic illustration of generating content using BCI signals, in accordance with some embodiments of this disclosure.

In some embodiments, user equipment 402 comprises biometric sensors to collect BCI signals 403 for use in generating visual representations 404 of any term the system determines to be ambiguous in a voice input 401. Biometric sensors may comprise, for example, electrodes, optical emitters and detectors, microphones, thermometers, thermistors, pressure sensors, respiratory sensors, eye-tracking systems, VOG systems, facial tracking systems, infrared cameras, thermal cameras, motion sensors, pulse oximeters, ultrasonic sensors, or other suitable sensor, or any combination thereof. For example, the system may determine voice input 401 contains the ambiguous word “apple.” At a time point substantially simultaneous to the microphone of user equipment 402 receiving the voice input 401, the biometric sensors may receive a biometric signal (e.g., EEG signals, fNIRS signals, etc.) corresponding to the voice input. For example, the BCI signal may include EEG signals. The system may process the BCI signals prior to determining correlations through mapping the BCI signal to a database or by providing the BCI signal to a neural network. In the EEG signal example, the system may filter the EEG (e.g., using ICA, bandpass filtering, etc.) to remove noise (e.g., eye blinks, muscle movements, etc.) and may normalize the EEG signal. The system may extract features (e.g., time-frequency features such as power in delta, theta, alpha, beta, and gamma bands) and map the extracted features to a database or by providing the extracted features to a neural network.

In some embodiments, the system may input EEG signals (or processed EEG signals (e.g., from step 305 of FIG. 3A)) from the biometric sensors and the voice input 401 (or processed voice signals (e.g., from step 307 of FIG. 3A)) into a multimodal latent diffusion model to generate visuals 404 from the EEG data using speech data to better correlate the subtle neural responses. For example, the multimodal latent diffusion model may determine associations between subtle neural responses from the EEG signals and specific phonemes, semantic cues, or even user-imagined attributes (e.g., color, style, texture, shape, size, etc.) to generate a visual for the ambiguous term of the voice input 401. For instance, the system may determine EEG signals, at a time point substantially simultaneous to the microphone of user equipment 402 receiving the voice input 401, correspond to a red apple and generate for display a visual representation 404 of a red apple.

FIG. 4B depicts a schematic illustration of generating content using mood signals, in accordance with some embodiments of this disclosure.

In some embodiments, user equipment 452 comprises mood sensors to collect mood signals 453 for use in generating visual representations 454 of any term the system determines to be ambiguous in a voice input 451. Mood sensors may comprise, for example electrodes, optical emitters and detectors, microphones, thermometers, thermistors, pressure sensors, respiratory sensors, eye-tracking systems, VOG systems, facial tracking systems, infrared cameras, thermal cameras, motion sensors, pulse oximeters, ultrasonic sensors, or other suitable sensor, or any combination thereof. The mood signal may comprise, for example, voice characteristics (e.g., vocal prosody including pitch, volume, and speaking rate), physiological signals (e.g., heart rate, GSR measurements, skin temperature, respiratory rate, blood pressure, pupil dilation, body posture changes, blood oxygen level, etc.), fEMG signals, camera-captured facial expression signals, etc.), or any combination thereof. For example, the system may determine voice input 451 contains the ambiguous word “jaguar.” At a time point substantially simultaneous to the microphone of user equipment 452 receiving the voice input 451, the mood sensors may receive a mood signal corresponding to the voice input. For example, the mood signal may include the voice input 451. In another example the mood signal may include an increase heart rate. The system may process mood signals prior to determining correlations through mapping the mood signal to a database or by providing the mood signal to a neural network. In the voice input as a mood signal example, the system may filter voice input 451 to remove background noise and may normalize voice input 451 in amplitude. The system may extract voice features (e.g., MFCCs and GTCCs) and map the extracted features to a database or by providing the extracted features to a neural network.

In some embodiments, the system may input mood signals (or processed mood signals (e.g., from step 305 of FIG. 3A)) from the mood sensors and the voice input 451 (or processed voice signals (e.g., from step 307 of FIG. 3A)) into a multimodal latent diffusion model to generate visuals 454 from the mood data using speech data to better correlate the subtle mood responses. For example, the multimodal latent diffusion model may determine associations between subtle mood responses and emotional states (e.g., calm, excited, stressed, nervous, positive, negative, etc.) to generate a visual for the ambiguous term of the voice input 451. For instance, the system may determine that mood signals, at a time point substantially simultaneous to the microphone of user equipment 452 receiving the voice input 451, correspond to emotions of awe and fear and generate for display a visual representation 454 of a jaguar cat.

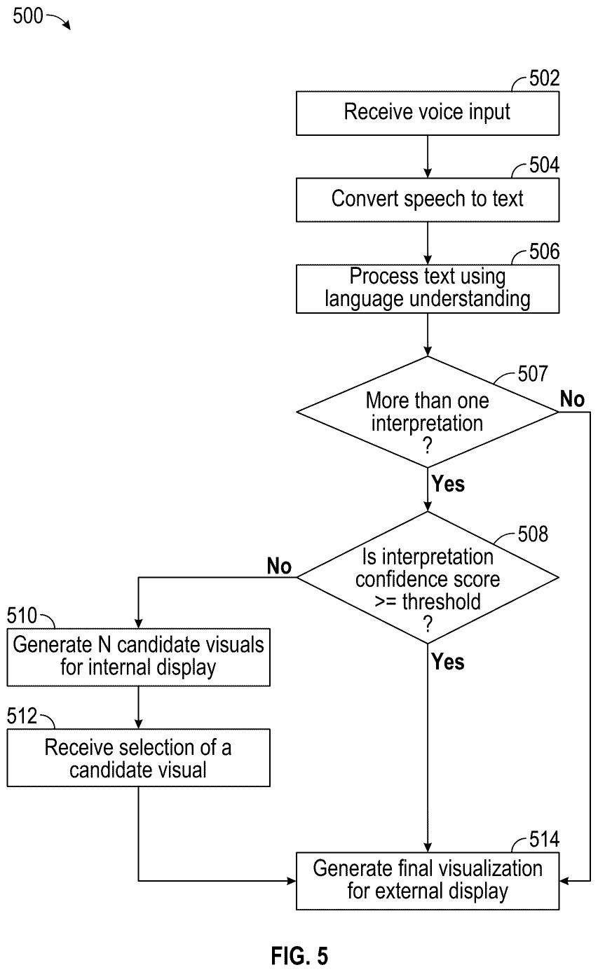

FIG. 5 depicts a flowchart of a process for generating content corresponding to an ambiguous term, in accordance with some embodiments of this disclosure. In various embodiments, the individual steps of process 500 may be implemented by one or more components of the devices, systems and methods of FIGS. 1-8 and may be performed in combination with any of the other processes and aspects described herein. Although the present disclosure may describe certain steps of process 500 (and of other processes described herein) as being implemented by certain components of the devices, systems and methods of FIGS. 1-8, this is for purposes of illustration only. It should be understood that, e.g., other components of the devices, systems and methods of FIGS. 1-8 may implement those steps instead.

In some embodiments, at 502, control circuitry (e.g., control circuitry 704 of FIG. 7, and/or control circuitry 811 of FIG. 8) running a media application receives a voice input. For example, the system (e.g., an HMD and/or server(s)), using an audio capture component (e.g., a microphone array integrated or in communication with the system), captures real-time audio. For instance, the audio capture component may have a configurable sample rate (e.g., between 16 kHz and 48 kHz) to capture audio based on a desired quality (e.g., higher sampling rate for better recognition accuracy) and/or consumption of computational resources (e.g., lower sampling rate to reduce computational resources).

In some embodiments, at 504, control circuitry running the media application converts the speech of the voice input to text through pre-processing and speech recognition.

For example, the media application may segment the sampled audio into frames (e.g., 20-30 milliseconds per frame) and input the frames into a noise cancellation algorithm (e.g., spectral subtraction, deep neural network-based denoising techniques, etc.) to separate speech from background noise. In some embodiments, the user equipment (e.g., user equipment 806, 807, 808, and/or 810 of FIG. 8) performs speech signal processing locally using an embedded digital signal processor (DSP). In some embodiments, a remote low-latency server performs speech signal processing, bandwidth permitting, and transmits the processed signal to the user equipment.

For example, the media application may transmit the processed (e.g., denoised) audio frames to a speech recognition component (e.g., speech recognition module 208 of FIG. 2, speech recognition module 308 of FIG. 3, a recurrent neural network transducer (RNN-T), a transformer-based model (e.g., Conformer architecture), etc., or any combination thereof). The speech recognition component transforms each incoming audio frame into text tokens (e.g., sub-word units, character-level tokens, etc.). The speech recognition component may further process the tokens using beam search to generate readable text with the most likely word sequence. The speech recognition component may additionally further process the tokens for text reformatting (e.g., punctuation, capitalization, etc.).

In some embodiments, in parallel to the speech processing, the media application may receive BCI and mood signals (e.g., EEG readings, fEMG readings, fNIRS signals, vocal prosody, physiological signals, camera-captured facial expression signals, etc., or any combination thereof). For example, the media application may sample an EEG signal at a rate of 256 Hz to 512 Hz, to balance temporal resolution with hardware constraints. In some embodiments, the media application may map (e.g., via multimodal fusion module 210 of FIG. 2 or NLU & ambiguity module 310 of FIG. 3A) the received signals to an emotional state or an excitement indicator corresponding to stress or excitement levels using an existing data structure and/or through a neural network. For example, the neural network may comprise a trained classifier that correlates the extracted features (e.g., time-frequency features, voice features, etc.) with vector embeddings of the trained classifier. For instance, vector embeddings are numerical representations of data in a continuous vector space used to encode complex data (e.g., words, images, patterns, behaviors, etc.) as embeddings, where embeddings with similar meanings or relationships are closer in the vector space. In some embodiments, the model may represent embeddings as vectors, matrices, tensors, or any other suitable mathematical form.

In some embodiments, at 506, control circuitry running a media application processes the converted text using language understanding to determine, at 507, whether more than one interpretation exists for each word or phrase of the converted text. For example, an NLU & ambiguity detection engine may comprise a tokenizer (e.g., Byte-Pair Encoding, WordPiece, etc.), and a semantic parser that uses either a large language model (e.g., BERT, GPT-based, a custom domain-specific model, etc.) and/or a set of rules to identify key terms. In some embodiments, the media application may maintain a dictionary of potentially ambiguous words and phrases (e.g., “apple,” “jaguar,” “bank,” etc.) stored in a data structure in the system memory (e.g., in storage circuitry 708 of FIG. 7, storage circuitry 814 of FIG. 8, or any other suitable storage). For example, each ambiguous word or phrase in the data structure is associated with a set of possible interpretations and metadata for each interpretation (e.g., classification, type, stock symbol, corresponding mood signals, corresponding BCI signals, etc.). For instance, the ambiguous word “apple,” is stored in association with interpretations and corresponding metadata: “red apple” (fruit, Red Delicious, 6-10cm, smooth, sweet, fall, etc.), “green apple” (fruit, Granny Smith, 6-9 cm, smooth, tart, fall, etc.), and “Apple Inc.” (brand, technology, Steve Jobs, AAPL, iOS, iPhone, etc.). The NLU & ambiguity module 310 may compare the transcribed text to the data structure to determine whether multiple interpretations exist for each word or phrase of the voice input. Furthermore, the NLU & ambiguity detection engine may use lexical analysis, language modeling, and contextual cues to determine a probability score, confidence score, or correlation score for each interpretation found in vector embeddings or a data structure. In some embodiments, subsequent to the NLU & ambiguity detection engine tokenizing and classifying potential meanings, the NLU & ambiguity detection engine generates a structured representation of the voice input (e.g., JSON object, a custom data structure listing each ambiguous term, accompanied by confidence scores and relevant metadata, etc.). For example, the NLU & ambiguity detection engine may process the voice input, “I just bought a new apple” and output interpretations and metadata: “fruit (red), 34%,” “fruit (green), 26%,” and “brand (Apple Inc.), 52%.”

In some embodiments, the NLU & ambiguity detection engine further utilizes BCI and mood data collected at the time of the voice input to determine whether multiple interpretations exist for each word or phrase of the voice input and/or to adjust the probability score, confidence score, or correlation score.

In some embodiments, the NLU & ambiguity detection engine further utilizes domain-specific heuristics (e.g., previous voice inputs, previous selection between ambiguity options, previous contextual patterns, etc.) to increase the probability of the corresponding interpretation. For example, the NLU & ambiguity detection engine may receive the voice input, “I just bought a new apple,” and determine a higher probability for the interpretation “Apple Inc” based on the media application receiving previous technology context.

In some embodiments, at step 508, control circuitry running a media application compares the confidence score to a configurable threshold. If the NLU & ambiguity detection engine determines that the probability score, confidence score, or correlation score of an interpretation is greater than a configurable threshold (e.g., 80%), the process proceeds to step 514. If the NLU & ambiguity detection engine determines that the probability score, confidence score, or correlation score of more than one interpretation is less than or equal to a configurable threshold (e.g., 80%), the process proceeds to step 510.

In some embodiments, at step 510, control circuitry running a media application generates a plurality of candidate visual representations for the ambiguous word or phrase interpretations for internal display. For example, the NLU & ambiguity detection engine may generate a prompt for each candidate interpretation less than or equal to the configurable threshold for input into a generative model module. As an example, the NLU & ambiguity detection engine prompt may include references to resolution, format, style, color, context, emotional state, etc. (e.g., “Generate a hyper realistic image of a bright red apple”). In some embodiments, the media application may use one or more generative AI services and/or models (e.g., Stable Diffusion, DALL-E, a custom-trained diffusion model, and/or any other suitable generative AI service, application, and/or model) to, e.g., generate for display candidate visual options of the interpretations on a private or personal display (e.g., internal display of HMD, or any suitable personal display). For example, candidate visual options may be displayed so they are distributed horizontally (e.g., one on the left-hand side, one on the right-hand side, and, if more than two, the other options in the middle), vertically (e.g., one on the top, one on the bottom, and, if more than two, the other options in the middle), or any distribution of the candidate options on the internal display that allows the media application to determine a selection of one of the candidate visual options. In some embodiments, the media application conserves computational resources by generating these visual options at a low resolution, in a scaled-down representation, or in lower computational and/or quality formats (e.g., text, lower resolution images, . gif image files, etc.).

In some embodiments, at 512, control circuitry running a media application receives a selection of a visual representation for the ambiguous word or phrase. For example, the media application may determine a selection of a candidate visual option through the biometric sensors (e.g., biometric sensors 206 of FIG. 2, biometric sensors 304 of FIG. 3, etc.). For example, the media application may receive data from an eye-tracking sensor correlating to the direction of one of the displayed visual representations to navigate and/or select. In another example, the media application may receive accelerometer data determining a gesture (e.g., head movement, head gaze, head tilt, hand gesture, etc.) that correlates to the direction of one of the displayed visual representations to navigate and/or select. In another example, the media application may receive data from a button, touchscreen, or controller to navigate and/or select. In some embodiments, the media application may generate an updated enriched text prompt (e.g., more detailed than the prompt of step 508), based on the selection and proceed to step 514.

In some embodiments, the media application may receive BCI data and/or mood data to confirm or reject a selection suggested by the eye-tracking correlation. For example, if the media application detects eye tracking correlated to selecting a visual option on the left-hand side, but the BCI data, at the time of selection, indicates a familiarity signal that suggests the person does not recognize the option, or determines the mood data, at the time of selection, indicates negative facial expressions (e.g., eyebrow furrowing, lip pursing, squinting, nostril flaring, etc.), increased skin conductance response (e.g., indicating emotional discomfort), erratic gaze patterns (e.g., increased blinking, shifting eye focus, longer reaction time, etc.), or any combination thereof that suggests the selection of the eye-tracked selection is incorrect, the media application may reject that selection. On the other hand, if the media application detects eye tracking correlated to selecting the visual option on the left-hand side, and the BCI data, at the time of selection, indicates a familiarity signal that suggests the person does recognize the option, or determines the mood data, at the time of selection, indicates positive facial expressions (e.g., relaxed eyebrows, slight smile, etc.), stable skin conductance, stable gaze patterns (e.g., reduced blinking, eye focus, shorter reaction time, etc.), or any combination thereof that suggests the selection of the eye-tracked selection is correct, the media application may accept that selection. In some embodiments, the media application may accept or reject a selection directly based on BCI data and/or mood data. In some embodiments, the media application may generate an updated enriched text prompt (e.g., more detailed than the prompt of step 508), based on the selection and the biometric data collected during the selection and proceed to step 514.

In some embodiments, subsequent to the selection of a visual representation for the ambiguous word or phrase, the media application may generate a prompt on the internal display to allow further input to refine attributes (e.g., color, style, texture, shape, size, etc.) or the format of the selected visual representation for display. For example, the media application may receive a voice input requesting the external display output to be in a video format. The media application may process the input refinement and generate a refined prompt to include the input refinement for input into a generative model module for a visualization on the external display.

In some embodiments, at step 514, control circuitry running a media application generates the visualization for external display. For example, the external display may be an external display of the user equipment 202, a display of a different user equipment (e.g., user equipment 806, 807, 808, and/or 810 of FIG. 8), or any combination thereof. In an embodiment, the media application may generate a visual on the external display at a high-resolution, in a scaled-up version or in higher computational and/or quality formats (e.g., higher resolution images, videos, audio, etc.).

FIG. 6 depicts a flowchart of a process for learning and feedback for generating content corresponding to an ambiguous term, in accordance with some embodiments of this disclosure.

In various embodiments, the individual steps of process 600 may be implemented by one or more components of the devices, systems and methods of FIGS. 1-8 and may be performed in combination with any of the other processes and aspects described herein. Although the present disclosure may describe certain steps of process 600 (and of other processes described herein) as being implemented by certain components of the devices, systems and methods of FIGS. 1-8, this is for purposes of illustration only. It should be understood that, e.g., other components of the devices, systems and methods of FIGS. 1-8 may implement those steps instead.

In some embodiments, at step 602, control circuitry (e.g., control circuitry 704 of FIG. 7, control circuitry 811 of FIG. 8, etc.) running a media application generates content corresponding to an ambiguous term. For example, the media application may implement one or more generative AI services and/or models using diffusion or generative adversarial network (GAN) based methods to create relevant visual outputs for each determined interpretation of an ambiguous word or phrase. For instance, the media application may determine “apple” is a fruit but may also determine that “apple” could be represented as a red apple or a green apple. As a result, the media application generates visuals of a red apple and a green apple for the UI manager to display on an internal display, visible only to the user. During the display of the candidate visual options, the eye-tracking and interaction manager determines user gaze vectors and captures dwell-based selections to identify the intended interpretation.

In some embodiments, at step 604, control circuitry running a media application logs selection and outcomes. For example, the media application may store (e.g., in storage circuitry 708 of FIG. 7, storage circuitry 814 of FIG. 8, or any other suitable storage) both the selected visual option and the unselected visual options. In some embodiments, the media application may also store BCI data, mood data, and/or system usage data.

In some embodiments, at step 606, control circuitry running a media application updates ambiguity statistics and usage data. For example, based on the stored data from step 604, the media application may refine probability distributions, update the data structure confidence scores, update metadata occurrence rates, etc.

In some embodiments, at step 608, control circuitry running a media application determines whether a pattern of repeated user preferences has occurred. If the media application determines a pattern of repeated user preferences has occurred, the process proceeds to step 610. If the media application determines a pattern of repeated user preferences has not occurred, the media application, at 612, determines that no data structure or model update is required at this time.

In some embodiments, at step 610, control circuitry running a media application adjusts weights or thresholds to favor the interpretation corresponding to the determined pattern for subsequent inferences. For example, the media application may refine probability distributions, incorporate historical context (e.g., selection patterns), adjust weights or thresholds of confidence scores in the data structure, refine or retrain the ambiguity model (e.g., language understanding and ambiguity model 212 of FIG. 2, or NLU & ambiguity module 310 of FIG. 3), and/or refine or retrain the generative model (e.g., generative model 214 of FIG. 2, or generative AI 312 of FIG. 3), etc., to adapt the media application to user-specific preferences, situational context, and domain-specific context of resolved ambiguities found in the determined patterns from the stored data. Thus, the media application refines future resolution strategies and reduces system resources for repeat ambiguities.

FIGS. 7-8 describe illustrative devices, systems, servers, and related hardware for generating content corresponding to an ambiguous term in speech, in accordance with some embodiments of the present disclosure. FIG. 7 shows generalized embodiments of illustrative user equipment 700 and 701, which may correspond to, e.g., user equipment 102 of FIG. 1; user equipment 202 of FIG. 2; user equipment 402 of FIG. 4A, and user equipment 452 of FIG. 4B. For example, user equipment 700 may be a smartphone device, a tablet, a computer, a near-eye display device, an XR device, or any other suitable device capable of viewing and/or editing media, e.g., locally or over a communication network. In another example, user equipment 701 may be a user television equipment system, gaming system, processor unit, computing unit, or other device. User equipment 701 may include set-top box 715. Set-top box 715 may be communicatively connected to microphone 716, audio output equipment 714 (e.g., speaker or headphones), and display 712. In some embodiments, microphone 716 may receive audio corresponding to a voice of a user and/or ambient audio data. In some embodiments, display 712 may be a television display, a computer display, a smartphone display, HMD, glasses, goggles, or any display of the aforementioned user equipment. In some embodiments, set-top box 715 may be communicatively connected to user input interface 710. In some embodiments, user input interface 710 may be a remote-control device, sensors that detect user commands, or a touchscreen display. Set-top box 715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path (e.g., I/O path 702). More specific implementations of user equipment are discussed below in connection with FIG. 8. In some embodiments, user equipment 700 may comprise, for example, any suitable number of sensors (e.g., gyroscope or gyrometer, accelerometer, or camera, etc.), and/or a GPS module (e.g., in communication with one or more servers and/or cell towers and/or satellites) to ascertain a location of user equipment 700. In some embodiments, user equipment 700 comprises a rechargeable battery that is configured to provide power to the components of the device.

Each one of user equipment 700 and user equipment 701 may receive content and data via I/O path 702. I/O path 702 may provide content (e.g., broadcast programming, on-demand programming, internet content, content available over a local area network (LAN) or wide area network (WAN), and/or other content) and data to control circuitry 704, which may comprise processing circuitry 706 and storage circuitry 708. Control circuitry 704 may be used to send and receive commands, requests, and other suitable data using I/O path 702, which may comprise I/O circuitry. I/O path 702 may connect control circuitry 704 to one or more communications paths (described below). I/O functions may be provided by one or more of these communications paths but are shown as a single path in FIG. 7 to avoid overcomplicating the drawing. While set-top box 715 is shown in FIG. 7 for illustration, any suitable computing device having processing circuitry, control circuitry, and storage may be used in accordance with the present disclosure. For example, set-top box 715 may be replaced by, or complemented by, a personal computer (e.g., a notebook, a laptop, a desktop, user equipment 807 of FIG. 8, etc.), a smartphone (e.g., user equipment 808 of FIG. 8), a television (e.g., user equipment 810 of FIG. 8), an XR device (e.g., user equipment 102 of FIG. 1, user equipment 202 of FIG. 2, user equipment 402 of FIG. 4A, and user equipment 452 of FIG. 4B, user equipment 806 of FIG. 8, etc.), a tablet, a network-based server hosting a user-accessible client device, a non-user-owned device, any other suitable device, or any combination thereof.

Control circuitry 704 may be based on any suitable control circuitry such as processing circuitry 706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i7 processor and an Intel Core i9 processor). In some embodiments, control circuitry 704 executes instructions for the media application (as described in connection with FIGS. 1-8) stored in memory (e.g., storage circuitry 708). Specifically, control circuitry 704 may be instructed by the media application to perform the functions discussed above and below. In some implementations, processing or actions performed by control circuitry 704 may be based on instructions received from the media application.

In client/server-based embodiments, control circuitry 704 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage circuitry 708 and executed by control circuitry 704 of a user equipment 700.

In some embodiments, the media application may be a client/server application where only the client application resides on user equipment 700, and a server application resides on an external server (e.g., server 804 of FIG. 8 and/or media content source 802 of FIG. 8). For example, the media application may be implemented partially as a client application on control circuitry 704 of user equipment 700 and partially on server 804 as a server application running on control circuitry 811. Server 804 may be a part of a local area network with one or more of user equipment 700, or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 804 and/or an edge computing device), referred to as “the cloud.” User equipment 700 may be a cloud client that relies on the cloud computing capabilities from server 804 to perform one or more of processes illustrated in FIGS. 1-6. The client application may instruct control circuitry 704 to generate video adjustments for better movement matching.

Control circuitry 704 may include communications circuitry suitable for communicating with a server, edge computing systems and devices, a table or database server, or other networks or servers. The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of user equipment, or communication of user equipment in locations remote from each other (described in more detail below).

Memory may be an electronic storage device provided as storage circuitry 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage circuitry 708 may be used to store various types of content described herein as well as media application data described above. Nonvolatile memory may also be used (e.g., to launch a boot-up routine and other instructions). Cloud-based storage, described in relation to FIG. 7, may be used to supplement storage circuitry 708 or instead of storage circuitry 708. Non-transitory memory may store instructions that, when executed by control circuitry, I/O circuitry, any other suitable circuitry or combination thereof, executes functions of a media application as described above.

Control circuitry 704 may include video generating circuitry and tuning circuitry, such as one or more MPEG-2 decoders or HEVC decoders or any other suitable digital decoding circuitry, high-definition tuners, one or more analog tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 704 may also include scaler circuitry for upconverting and downconverting content into the preferred output format of user equipment 700. Control circuitry 704 may also include digital-to-analog converter circuitry and analog-to-digital converter circuitry for converting between digital and analog signals. The tuning and encoding circuitry may be used by user equipment 700 and 701 to receive and to display, to play, or to record content. The tuning and encoding circuitry may also be used to receive video and/or audio communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage circuitry 708 is provided as a separate device from user equipment 700, the tuning and encoding circuitry (including multiple tuners) may be associated with storage circuitry 708.

Control circuitry 704 may receive instruction from a user by way of user input interface 710. User input interface 710 may be any suitable user interface, such as a remote control, mouse, trackball, keypad, keyboard, touchscreen, touchpad, stylus input, joystick, voice recognition interface, sensor interface (e.g., to track body movement, eye gaze, biometric parameters, etc.), or other user input interfaces. Display 712 may be provided as a stand-alone device or integrated with other elements of each one of user equipment 700 and user equipment 701. For example, display 712 may be a touchscreen or touch-sensitive display. In such circumstances, user input interface 710 may be integrated with or combined with display 712. In some embodiments, user input interface 710 includes a remote-control device having one or more microphones, buttons, keypads, sensors, or any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top box 715.

Audio output equipment 714 may be integrated with or combined with display 712, and/or an HMD. Display 712 may be one or more of a monitor, television, liquid crystal display (LCD) for an HMD, mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, projection, or any other suitable equipment for displaying visual images. A video card or graphics card may generate the output to the display 712. Audio output equipment 714 may be provided as integrated with other elements of each one of user equipment 700 and user equipment 701 or may be stand-alone units. An audio component of videos and other content displayed on display 712 may be played through speakers (or headphones) of audio output equipment 714. In some embodiments, audio may be distributed to a receiver, which processes and outputs the audio via speakers of audio output equipment 714. In some embodiments, for example, control circuitry 704 is configured to provide audio cues to a user, or other audio feedback to a user, using speakers of audio output equipment 714. There may be a separate microphone 716 or audio output equipment 714 may include a microphone configured to receive audio input such as voice commands or speech. For example, a user may speak letters or words that are received by the microphone and converted to text by control circuitry 704. In a further example, a user may provide voice commands that are received by a microphone and recognized by control circuitry 704. Camera 718 may be any suitable video camera integrated with the equipment or externally connected. Camera 718 may be a digital camera comprising a charge-coupled device (CCD) and/or a complementary metal-oxide semiconductor (CMOS) image sensor. Camera 718 may be an analog camera that converts to digital images via a video card.

The media application may be implemented using any suitable architecture. For example, it may be a stand-alone application wholly implemented on each one of user equipment 700 and user equipment 701. In such an approach, instructions of the application may be stored locally (e.g., in storage circuitry 708), and data for use by the application is downloaded on a periodic basis (e.g., from an out-of-band feed, from an internet resource, or using another suitable approach). Control circuitry 704 may retrieve instructions of the application from storage circuitry 708 and process the instructions to provide video conferencing functionality and generate any of the displays discussed herein. Based on the processed instructions, control circuitry 704 may determine what action to perform when input is received from user input interface 710. For example, movement of a cursor or selection field on a display up/down may be indicated by the processed instructions when user input interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), flash drives, NVMe, NAS, etc.

Control circuitry 704 may allow a user to provide user profile information or may automatically compile user profile information. For example, control circuitry 704 may access and monitor network data, video data, audio data, processing data, content consumption data, and/or any other suitable data being accessed by a user. Control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the media application is a client/server-based application. Data for use by a thick or thin client implemented on each one of user equipment 700 and user equipment 701 may be retrieved on demand by issuing requests to a server remote to each one of user equipment 700 and user equipment 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on user equipment 700. This way, the processing of the instructions is performed remotely by the server while the resulting displays (e.g., that may include text, a keyboard, or other visuals) are provided locally on user equipment 700. User equipment 700 may receive inputs from the user via user input interface 710 and transmit those inputs to the remote server for processing and generating the corresponding displays. For example, user equipment 700 may transmit a communication to the remote server indicating that an up/down button was selected via user input interface 710. The remote server may process instructions in accordance with that input and generate a display of the application corresponding to the input (e.g., a display that moves a cursor up/down). The generated display is then transmitted to user equipment 700 for presentation to the user.

In some embodiments, the media application may be downloaded and interpreted or otherwise run by an interpreter or virtual machine (e.g., run by control circuitry 704). In some embodiments, the media application may be encoded in the ETV Binary Interchange Format (EBIF), received by control circuitry 704 as part of a suitable feed, and interpreted by a user agent running on control circuitry 704. For example, the media application may be an EBIF application. In some embodiments, the media application may be defined by a series of JAVA-based files that are received and run by a local virtual machine or other suitable middleware executed by control circuitry 704. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

As shown in FIG. 8, user equipment 806, 807, 808, and/or 810 (which may correspond to user equipment user equipment 102 of FIG. 1, user equipment 202 of FIG. 2, user equipment 402 of FIG. 4A, and user equipment 452 of FIG. 4B) may be coupled to communication network 809. Communication network 809 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 809) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 802-11x, etc.), or other short-range communication via wired or wireless paths. The user equipment may also communicate with each other directly through an indirect path via communication network 809.

System 800 may comprise media content source 802, one or more servers 804, and/or one or more edge computing devices. In some embodiments, the media application may be executed at one or more of control circuitry 811 of server 804 (and/or control circuitry of user equipment 806, 807, 808, 810 and/or control circuitry of one or more edge computing devices). In some embodiments, the media content source and/or server 804 may be configured to host or otherwise facilitate video and/or audio communication sessions between user equipment 806, 807, 808, 810 and/or any other suitable user equipment, and/or host or otherwise be in communication (e.g., over communication network 809) with one or more social network services.

In some embodiments, server 804 may include control circuitry 811 and storage circuitry 814 (e.g., RAM, ROM, Hard Disk, Removable Disk, etc.). Storage 814 may store one or more databases. Server 804 may also include an I/O path 812. In some embodiments, I/O path 812 is an I/O circuitry. I/O circuitry may be a NIC card, audio output device, mouse, keyboard card, voice recognition interface, sensor interface, any other suitable I/O circuitry device or combination thereof. I/O path 812 may provide video conferencing data, device information, or other data, over a local area network (LAN) or wide area network (WAN), and/or other content and data to control circuitry 811, which may include processing circuitry, and storage circuitry 814. Control circuitry 811 may be used to send and receive commands, requests, and other suitable data using I/O path 812, which may comprise I/O circuitry. I/O path 812 may connect control circuitry 811 to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i7 processor and an Intel Core i9 processor). In some embodiments, control circuitry 811 executes instructions for an emulation system application stored in memory (e.g., the storage circuitry 814). Memory may be an electronic storage device provided as storage circuitry 814 that is part of control circuitry 811. Memory may store instruction to run the media application.

The terminology used herein is for the purpose of describing particular embodiments only and is not intended to be limiting of the disclosure.

It is to be understood that various terms relating to latency may be understood as set forth in the following. These latency terms are not intended to be limiting but exemplary. “High” latency is, e.g., about 45 seconds or more. An example of this is DASH and/or HLS with 10-second segments. “Typical” latency ranges, e.g., from about 10 to about 45 seconds. This can be seen in DASH and/or HLS with 6-second segments. DASH and/or HLS with 2-second segments falls between low latency and typical latency. “Low” latency is, e.g., between about 1 and 10 seconds. Examples include DASH and/or HLS with fragmented or 1-second segments, cable, IPTV, satellite, over-the-air broadcast, social media, messaging, live sports, game streaming, and eSports. Online gambling, betting, and auctioning fall between ultra-low latency and low latency. “Ultra-low” latency is, e.g., about 100 milliseconds to about 1 second. Cloud gaming, videoconferencing, and Voice over IP (VOIP) straddle the line between near-real-time latency and ultra-low latency. “Near-real-time” latency is, e.g., less than about 100 milliseconds. An example of this is surgical robots. Other examples include different game genres. For example, for a role-playing fantasy game, a latency of less than about 100 milliseconds is likely sufficient. Whereas, in a first-person shooter game, end-to-end latency below about 40 milliseconds is desirable. In another example, XR and/or VR cloud gaming pushes these latencies even lower to below about 20 milliseconds.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud-computing environments.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first,” “second,” “third,” and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random-access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed above are intended to be illustrative and not limiting. One skilled in the art would appreciate that the actions of the processes discussed herein may be omitted, modified, combined and/or rearranged, and any additional actions may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving speech data via a microphone of a head-mounted display;
determining text data from at least a portion of the speech data;
identifying an ambiguous term in the text data;
determining a weight for each of a plurality of interpretations for the ambiguous term based at least in part on a brain-computer interface (BCI) signal;
based at least in part on the determined weight for each of the plurality of interpretations for the ambiguous term, selecting a subset of the plurality of interpretations;
providing an input prompt for each of the subset of the plurality of interpretations to a generative model trained to generate a visual output based at least in part on an input prompt, to generate one or more candidate visual options for the subset of the plurality of interpretations; and
providing for display, on an internal display of the head-mounted display, the one or more candidate visual options for the subset of the plurality of interpretations.

2. The method of claim 1, wherein the ambiguous term is determined, by a language model, to have more than one interpretation.

3. The method of claim 1, wherein the ambiguous term is determined, by a language model, to have more than one language translation.

4. The method of claim 1, wherein a temporal range of the BCI signal utilized for determining the weight for each of the plurality of interpretations for the ambiguous term is substantially simultaneous with the receiving the speech data via the microphone of the head-mounted display.

5. The method of claim 1, wherein the determining the weight for each of the plurality of interpretations for the ambiguous term based at least in part on the BCI signal comprises: processing the BCI signal to remove noise;
extracting time-frequency features from the processed BCI signal;
providing the extracted time-frequency features to a trained classifier to correlate the time-frequency features with vector embeddings;
generating the weight based at least in part on a probability score of the correlated time-frequency features and the vector embeddings.

6. The method of claim 1, further comprising:
receiving a selection of the one or more candidate visual options; and
providing for display, on an external display, a representation of the selected visual option.

7. The method of claim 6, wherein the external display is an external display of the head-mounted display, an internal display of a different head-mounted display, or a different external display.

8. The method of claim 6, wherein the receiving the selection of the one or more candidate visual options comprises receiving data from an eye-tracking sensor correlating to a direction of the selected one or more candidate visual option.

9. The method of claim 1, wherein the BCI signal comprises data corresponding to attributes of the ambiguous term.

10. The method of claim 1, wherein the determining the weight for each of the plurality of
interpretations for the ambiguous term further comprises:
receiving a mood signal at a timepoint substantially simultaneous with the receiving the speech data via the microphone of the head-mounted display;
processing the mood signal to remove noise;
extracting voice features from the processed mood signal;
providing the extracted voice features to a trained classifier to correlate the voice features with vector embeddings;
generating the weight based at least in part on a probability score of the correlated voice features and the vector embeddings.

11. A system comprising:
memory;
input/output circuitry configured to:
receive speech data via a microphone of a head-mounted display;
control circuitry configured to:
determine text data from at least a portion of the speech data;
identify an ambiguous term in the text data;
determine a weight for each of a plurality of interpretations for the ambiguous term based at least in part on a brain-computer interface (BCI) signal;
based at least in part on the determined weight for each of the plurality of interpretations for the ambiguous term, selecting a subset of the plurality of interpretations;
provide an input prompt for each of the subset of the plurality of interpretations to a generative model trained to generate a visual output based at least in part on an input prompt, to generate one or more candidate visual options for the subset of the plurality of interpretations; and
wherein the input/output circuitry is further configured to:
provide for display, on an internal display of the head-mounted display, the one or more candidate visual options for the subset of the plurality of interpretations.

12. The system of claim 11, wherein the ambiguous term is determined, by a language model, to have more than one interpretation.

13. The system of claim 11, wherein the ambiguous term is determined, by a language model, to have more than one language translation.

14. The system of claim 11, wherein a temporal range of the BCI signal utilized for determining the weight for each of the plurality of interpretations for the ambiguous term is substantially simultaneous with the receiving the speech data via the microphone of the head-mounted display.

15. The system of claim 11, wherein the control circuitry configured to determine the weight for
each of the plurality of interpretations for the ambiguous term based at least in part on the BCI signal is further configured to:
process the BCI signal to remove noise;
extract time-frequency features from the processed BCI signal;
provide the extracted time-frequency features to a trained classifier to correlate the time-frequency features with vector embeddings; and
generate the weight based at least in part on a probability score of the correlated time-frequency features and the vector embeddings.

16. The system of claim 11, wherein the input/output circuitry is further configured to:
receive a selection of the one or more candidate visual options; and
provide for display, on an external display, a representation of the selected visual option.

17. The system of claim 16, wherein the external display is an external display of the head-mounted display, an internal display of a different head-mounted display, or a different external display.

18. The system of claim 16, wherein the input/output circuitry configured to receive the selection of the one or more candidate visual options is further configured to receive data from an eye-tracking sensor correlating to a direction of the selected one or more candidate visual option.

19. The system of claim 11, wherein the BCI signal comprises data corresponding to attributes of the ambiguous term.

20. The system of claim 11, wherein the control circuitry configured to determine the weight for
each of the plurality of interpretations for the ambiguous term is further configured to:
receive a mood signal at a timepoint substantially simultaneous with the receiving the speech data via the microphone of the head-mounted display;
process the mood signal to remove noise;
extract voice features from the processed mood signal;
provide the extracted voice features to a trained classifier to correlate the voice features with vector embeddings;
generate the weight based at least in part on a probability score of the correlated voice features and the vector embeddings.

21-50. (canceled)
